(19) United States
(12) Patent Application Publication
(10) Pub. No.: US 2024/0178521 A1
(43) Pub. Date: May 30, 2024

(54) METHODS AND STRUCTURES FOR TRANSFER OF CARRIER IONS THROUGH CONSTRAINT SYSTEM FROM AUXILIARY ELECTRODE

(71) Applicant: Enovix Corporation, Fremont, CA (US)

(72) Inventors: Neelam Singh, Fremont, CA (US); Robert S. Busacca, San Francisco, CA (US); Jonathan C. Doan, Pleasanton, CA (US); Murali Ramasubramanian, Fremont, CA (US); Robert Keith Rosen, Rocklin, CA (US)

(21) Appl. No.: 18/284,820

(22) PCT Filed: Mar. 30, 2022
(86) PCT No.: PCT/US2022/022439

§ 371 Date: Sep. 28, 2023

Related U.S. Application Data
(60) Provisional application No. 63/168,638, filed on Mar. 31, 2021.

(51) Int. Cl. H01M 50/46; H01M 10/0585; H01M 50/446; H01M 50/491

(52) U.S. Cl. CPC H01M 50/46; H01M 10/0585; H01M 50/446; H01M 50/491

(57) ABSTRACT

A method for transferring carrier ions from an auxiliary electrode to an electrode assembly through a constraint system. The electrode assembly includes a population of unit cells that each includes an electrode structure, a counter-electrode structure, and an electrically insulating separator. The electrode assembly is enclosed within a volume defined by the constraint system comprising (i) first and second primary growth constraints separated in the stacking direction, and (ii) first and second secondary growth constraints separated in the vertical direction, wherein (iii) the first and secondary growth constraints are connected to upper and lower end surface(s) of the electrode or counter-electrode structures, and comprise a plurality of apertures having porous electrically insulating material disposed therein having a porosity in the range of from 20% to 60%. Carrier ions are transferred from the auxiliary electrode through the porous electrically insulating material to members of the unit cell population.

### CROSS REFERENCE TO RELATED APPLICATIONS

The present application claims benefit of U.S. Provisional Patent Application Ser. No. 63/168,638, filed on Mar. 31, 2021, which application is incorporated by reference herein in its entirety.

### FIELD OF THE INVENTION

This disclosure generally relates to methods and structures for use in energy storage devices, to energy storage devices employing such structures, and to methods for producing such structures and energy devices.

### BACKGROUND

Rocking chair or insertion secondary batteries are a type of energy storage device in which carrier ions, such as lithium, sodium, potassium, calcium or magnesium ions, move between a positive electrode and a negative electrode through an electrolyte, such as a solid or liquid electrolyte. The secondary battery may comprise a single battery cell, or two or more battery cells that have been electrically coupled to form the battery, with each battery cell comprising a positive electrode, a negative electrode, an electrically insulating separator, and an electrolyte. In solid state secondary batteries, a single solid state material can serve as both the electrically insulating separator and the electrolyte.

In rocking chair battery cells, both the positive and negative electrodes comprise materials into which a carrier ion inserts and extracts. As a cell is discharged, carrier ions are extracted from the negative electrode and inserted into the positive electrode. As a cell is charged, the reverse process occurs: the carrier ion is extracted from the positive and inserted into the negative electrode.

However, as a part of this carrier ion extraction and insertion process that occurs during charging and/or discharging of the secondary battery, at least a portion of the carrier ions can be irreversibly lost to the electrochemical reaction. For example, a decomposition product comprising lithium (or other carrier ions) and electrolyte components, known as solid electrolyte interphase (SEI) can forms on the surfaces of the negative electrodes. The formation of this SEI layer traps carrier ions and removes them from the cyclic operation of the secondary battery, and leading to irreversible capacity loss. Other chemical and electrochemical process in the electrode assembly can also contribute to a loss of carrier ions. Such losses often occur during the initial charging steps performed as a part of the formation process for the secondary batteries, e.g. due to formation of the SEI layer in the initial charging steps, resulting in significantly lower capacities compared to the amount of carrier ion contained in the secondary battery pre-formation.

Methods for the replenishment of electrodes of secondary batteries have been described (see, e.g., U.S. Pat. No. 10,770,760 to Castledine et al., which is hereby incorporated by reference herein in its entirety). However, there remains a need for new methods and structures for effectively and efficiently providing carrier ions to secondary batteries to replenish lost carrier ions.

Among the various aspects of the present disclosure is the provision of energy storage devices such as secondary batteries, fuel cells, and electrochemical capacitors in which capacity lost as a result of SEI formation and/or mechanical or electrical degradation of the negative electrode and/or the positive electrode may be restored. Advantageously, energy storage devices of the present disclosure offer increased cycle life, higher energy density, and/or increased discharge rate.

### SUMMARY

Briefly, therefore, one aspect of this disclosure relates to a method for transferring carrier ions from an auxiliary electrode comprising a source of carrier ions to an electrode assembly through a constraint system, wherein the electrode assembly includes a population of unit cells stacked in series in a stacking direction, and wherein (i) each unit cell includes an electrode structure, a counter-electrode structure, and an electrically insulating separator between the electrode and counter-electrode structures, (ii) the electrode structures, counter-electrode structures and electrically insulating separators within each unit cell have opposing upper and lower end surfaces separated in a vertical direction, and (iii) the vertical direction is orthogonal to the stacking direction. The electrode assembly is enclosed within a volume defined by the constraint system, the constraint system having (i) first and second primary growth constraints separated in the stacking direction, and (ii) first and second secondary growth constraints separated in the vertical direction and connecting the first and second primary growth constraints, wherein (iii) the first secondary growth constraint is further connected to the upper end surface(s) of the electrode or counter-electrode structures of a subset of members of the unit cell population, (iv) the second secondary growth constraint is further connected to the lower end surface(s) of the electrode or counter-electrode structures of a subset of members of the unit cell population, and (v) the first or second secondary growth constraint includes a plurality of apertures through a vertical thickness thereof. A porous electrically insulating material is disposed within the plurality of apertures, the porous electrically insulating material providing a path for carrier ions through the apertures, the porous electrically insulating material having a porosity in the range of from 20% to 60%, and the auxiliary electrode is located outside the volume enclosed by the constraint system. The method comprises transferring carrier ions from the auxiliary electrode through the porous electrically insulating material within the apertures to members of the unit cell population.

Another aspect of this disclosure relates to an electrode assembly having a constraint system for a secondary battery, the electrode assembly including a population of unit cells stacked in series in a stacking direction, wherein (i) each unit cell comprises an electrode structure, a counter-electrode structure, and an electrically insulating separator between the electrode and counter-electrode structures, (ii) the electrode structures, counter-electrode structures and electrically insulating separators within each unit cell have opposing upper and lower end surfaces separated in a vertical direction, and (iii) the vertical direction is orthogonal to the stacking direction. The electrode assembly is enclosed within a volume defined by the constraint system, the constraint system comprising (i) first and second primary growth constraints separated in the longitudinal direction, and (ii) first and second secondary growth constraints separated in the vertical direction and connecting the first and second primary growth constraints, wherein (iii) the first secondary growth constraint is further connected to the upper end surfaces of the electrode or counter-electrode structures of a subset of the unit cell population, (iv) the second secondary growth constraint is further connected to the lower end surfaces of the electrode or counter-electrode structures of a subset of the unit cell population, and (v) the first or second secondary growth constraint comprises a plurality of apertures through a vertical thickness thereof. A porous electrically insulating material disposed within the plurality of apertures, the porous electrically insulating material providing a path for carrier ions through the apertures, the electrically insulating material having a porosity in the range of from 20% to 60%. Another aspect of this disclosure relates to a secondary battery comprising the electrode assembly.

Another aspect of this disclosure relates to a method of manufacturing the electrode assembly or the secondary battery, the method including (1) stacking the population of unit cells stacked in series in the stacking direction, wherein (i) each unit cell includes the electrode structure, the counter-electrode structure, and the electrically insulating separator between the electrode and counter-electrode structures, (ii) the electrode structures, counter-electrode structures and electrically insulating separators within each unit cell have opposing upper and lower end surfaces separated in a vertical direction, and (iii) the vertical direction is orthogonal to the stacking direction. The method further includes (2) enclosing the population of unit cells within the volume defined by the constraint system including (i) first and second primary growth constraints separated in the longitudinal direction, and (ii) first and second secondary growth constraints separated in the vertical direction and connecting the first and second primary growth constraints, wherein (iii) the first secondary growth constraint is further connected to the upper end surfaces of the electrode or counter-electrode structures of a subset of the unit cell population, (iv) the second secondary growth constraint is further connected to the lower end surfaces of the electrode or counter-electrode structures of the subset of the unit cell population, and (v) the first or second secondary growth constraint comprises the plurality of apertures through a vertical thickness thereof. The method further includes (3) providing porous electrically insulating material within the plurality of apertures, the porous electrically insulating material providing the path for carrier ions through the apertures, the electrically insulating material having the porosity in the range of from 20% to 60%.

Other aspects, features and embodiments of the present disclosure will be, in part, discussed and, in part, apparent in the following description and drawings.

### BRIEF DESCRIPTION OF THE DRAWING

FIG. 1A is a perspective view of one embodiment of an electrode assembly with a set of electrode constraints.

FIG. 1B is a schematic of one embodiment of a three-dimensional electrode assembly for a secondary battery.

FIG. 1C is an inset cross-sectional view of the electrode assembly of FIG. 1B.

FIG. 1D is a cross-sectional view of the electrode assembly of FIG. 1B, taken along line D in FIG. 1B.

FIG. 2 illustrates an exploded view of an embodiment of an energy storage device or a secondary battery comprising an electrode assembly and a set of electrode constraints.

FIG. 3A illustrates a cross-section in a Z-Y plane, of an embodiment of an electrode assembly, with an auxiliary electrodes.

FIG. 3B illustrates a top view in the X-Y plane, of an embodiment of an electrode assembly, with a set of electrode constraints having apertures therein.

FIG. 4 is a cross-sectional view of an embodiment of an electrode assembly comprising a porous electrically insulating material.

FIGS. 5A and 5B are top views of embodiments of an electrode assembly with a secondary growth constraint system, where FIG. 5A depicts the electrode assembly having a porous electrically insulating material over upper and/or lower end surfaces of electrodes and/or counter-electrodes of the electrode assembly, and prior to providing porous electrically insulating material to apertures in the secondary growth constraint system, and FIG. 5B depicts the electrode assembly having porous electrically insulating material provided to the apertures in the secondary growth constraint system.

FIG. 6 is a schematic depicting an embodiment of a part of a process for providing a porous electrically insulating material to a plurality of apertures in a secondary growth constraint system.

FIG. 7A illustrates a cross-section of an embodiment of the electrode assembly taken along the line A-A′ as shown in FIG. 1A, and illustrates elements of embodiments of primary and secondary growth constraint systems.

FIG. 7B illustrates a cross-section of an embodiment of the electrode assembly taken along the line B-B′ as shown in FIG. 1A, and illustrates elements of embodiments of primary and secondary growth constraint systems.

FIG. 7C illustrates a cross section of an embodiment of the electrode assembly taken along the line A-A′ as shown in FIG. 1A, and illustrates further elements of embodiments of primary and secondary growth constraint systems.

Other aspects, embodiments and features of the inventive subject matter will become apparent from the following detailed description when considered in conjunction with the accompanying drawing. The accompanying figures are schematic and are not intended to be drawn to scale. For purposes of clarity, not every element or component is labeled in every figure, nor is every element or component of each embodiment of the inventive subject matter shown where illustration is not necessary to allow those of ordinary skill in the art to understand the inventive subject matter.

### Definitions

“A,” “an,” and “the” (i.e., singular forms) as used herein refer to plural referents unless the context clearly dictates otherwise. For example, in one instance, reference to “an electrode” includes both a single electrode and a plurality of similar electrodes.

“About” and “approximately” as used herein refers to plus or minus 10%, 5%, or 1% of the value stated. For example, in one instance, about 250 μm would include 225 μm to 275 μm. By way of further example, in one instance, about 1,000 μm would include 900 μm to 1,100 μm. Unless otherwise indicated, all numbers expressing quantities (e.g., measurements, and the like) and so forth used in the specification and claims are to be understood as being modified in all instances by the term “about.” Accordingly, unless indicated to the contrary, the numerical parameters set forth in the following specification and attached claims are approximations. Each numerical parameter should at least be construed in light of the number of reported significant digits and by applying ordinary rounding techniques.

“Charged state” as used herein in the context of the state of a secondary battery refers to a state where the secondary battery is charged to at least 75% of its rated capacity. For example, the battery may be charged to at least 80% of its rated capacity, at least 90% of its rated capacity, and even at least 95% of its rated capacity, such as 100% of its rated capacity.

“C-rate” as used herein refers to a measure of the rate at which a secondary battery is discharged, and is defined as the discharge current divided by the theoretical current draw under which the battery would deliver its nominal rated capacity in one hour. For example, a C-rate of 1C indicates the discharge current that discharges the battery in one hour, a rate of 2C indicates the discharge current that discharges the battery in ½ hours, a rate of C/2 indicates the discharge current that discharges the battery in 2 hours, etc.

“Discharged state” as used herein in the context of the state of a secondary battery refers to a state where the secondary battery is discharged to less than 25% of its rated capacity. For example, the battery may be discharged to less than 20% of its rated capacity, such as less than 10% of its rated capacity, and even less than 5% of its rated capacity, such as 0% of its rated capacity.

A “cycle” as used herein in the context of cycling of a secondary battery between charged and discharged states refers to charging and/or discharging a battery to move the battery in a cycle from a first state that is either a charged or discharged state, to a second state that is the opposite of the first state (i.e., a charged state if the first state was discharged, or a discharged state if the first state was charged), and then moving the battery back to the first state to complete the cycle. For example, a single cycle of the secondary battery between charged and discharged states can include, as in a charge cycle, charging the battery from a discharged state to a charged state, and then discharging back to the discharged state, to complete the cycle. The single cycle can also include, as in a discharge cycle, discharging the battery from the charged state to the discharged state, and then charging back to a charged state, to complete the cycle.

For the term “electrode” as used in “electrode structure” or “electrode active material,” it is to be understood that such structure and/or material may in certain embodiments correspond that of a “negative electrode,” such as an “anode,” as used for example in “negative electrode structure,” “anode structure,” “negative electrode active material,” and “anodically active material.” For the term “counter-electrode” as used in “counter-electrode structure” or “counter-electrode active material,” it is to be understood that such structure and/or material may in certain embodiments correspond that of a “positive electrode,” such as a “cathode,” as used for example in “positive electrode structure,” “cathode structure,” “positive electrode active material,” and “cathodically active material.” That is, where suitable, any embodiments described for an electrode and/or counter-electrode may correspond to the same embodiments where the electrode and/or counter-electrode are specifically a negative electrode and/or positive electrode, including their corresponding structures and materials, respectively.

“Longitudinal axis,” “transverse axis,” and “vertical axis,” as used herein refer to mutually perpendicular axes (i.e., each are orthogonal to one another). For example, the “longitudinal axis,” “transverse axis,” and the “vertical axis” as used herein are akin to a Cartesian coordinate system used to define three-dimensional aspects or orientations. As such, the descriptions of elements of the inventive subject matter herein are not limited to the particular axis or axes used to describe three-dimensional orientations of the elements. Alternatively stated, the axes may be interchangeable when referring to three-dimensional aspects of the inventive subject matter.

“Longitudinal direction,” “transverse direction,” and “vertical direction,” as used herein, refer to mutually perpendicular directions (i.e., each are orthogonal to one another). For example, the “longitudinal direction,” “transverse direction,” and the “vertical direction” as used herein may be generally parallel to the longitudinal axis, transverse axis and vertical axis, respectively, of a Cartesian coordinate system used to define three-dimensional aspects or orientations.

“Repeated cycling” as used herein in the context of cycling between charged and discharged states of the secondary battery refers to cycling more than once from a discharged state to a charged state, or from a charged state to a discharged state. For example, repeated cycling between charged and discharged states can including cycling at least 2 times from a discharged to a charged state, such as in charging from a discharged state to a charged state, discharging back to a discharged state, charging again to a charged state and finally discharging back to the discharged state. As yet another example, repeated cycling between charged and discharged states at least 2 times can include discharging from a charged state to a discharged state, charging back up to a charged state, discharging again to a discharged state and finally charging back up to the charged state By way of further example, repeated cycling between charged and discharged states can include cycling at least 5 times, and even cycling at least 10 times from a discharged to a charged state. By way of further example, the repeated cycling between charged and discharged states can include cycling at least 25, 50, 100, 300, 500 and even 1000 times from a discharged to a charged state.

“Rated capacity” as used herein in the context of a secondary battery refers to the capacity of the secondary battery to deliver a specified current over a period of time, as measured under standard temperature conditions (25° C.). For example, the rated capacity may be measured in units of Amp·hour, either by determining a current output for a specified time, or by determining for a specified current, the time the current can be output, and taking the product of the current and time. For example, for a battery rated 20 Amp·hr, if the current is specified at 2 amperes for the rating, then the battery can be understood to be one that will provide that current output for 10 hours, and conversely if the time is specified at 10 hours for the rating, then the battery can be understood to be one that will output 2 amperes during the 10 hours. In particular, the rated capacity for a secondary battery may be given as the rated capacity at a specified discharge current, such as the C-rate, where the C-rate is a measure of the rate at which the battery is discharged relative to its capacity. For example, a C-rate of 1C indicates the discharge current that discharges the battery in one hour, 2C indicates the discharge current that discharges the battery in ½ hours, C/2 indicates the discharge current that discharges the battery in 2 hours, etc. Thus, for example, a battery rated at 20 Amp·hr at a C-rate of 1C would give a discharge current of 20 Amp for 1 hour, whereas a battery rated at 20 Amp·hr at a C-rate of 2C would give a discharge current of 40 Amps for % hour, and a battery rated at 20 Amp·hr at a C-rate of C/2 would give a discharge current of 10 Amps over 2 hours.

“Maximum width” (W_{EA}) as used herein in the context of a dimension of an electrode assembly corresponds to the greatest width of the electrode assembly as measured from opposing points of longitudinal end surfaces of the electrode assembly in the longitudinal direction.

“Maximum length” (L_{EA}) as used herein in the context of a dimension of an electrode assembly corresponds to the greatest length of the electrode assembly as measured from opposing points of a lateral surface of the electrode assembly in the transverse direction.

“Maximum height” (H_{EA}) as used herein in the context of a dimension of an electrode assembly corresponds to the greatest height of the electrode assembly as measured from opposing points of the lateral surface of the electrode assembly in the transverse direction.

### DETAILED DESCRIPTION

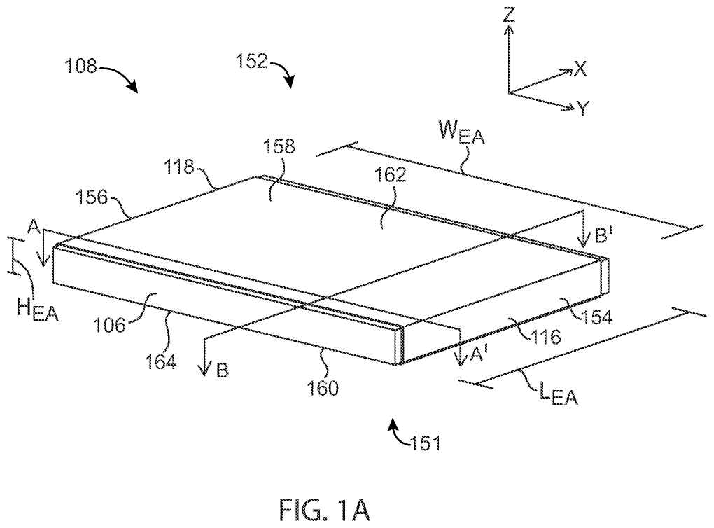

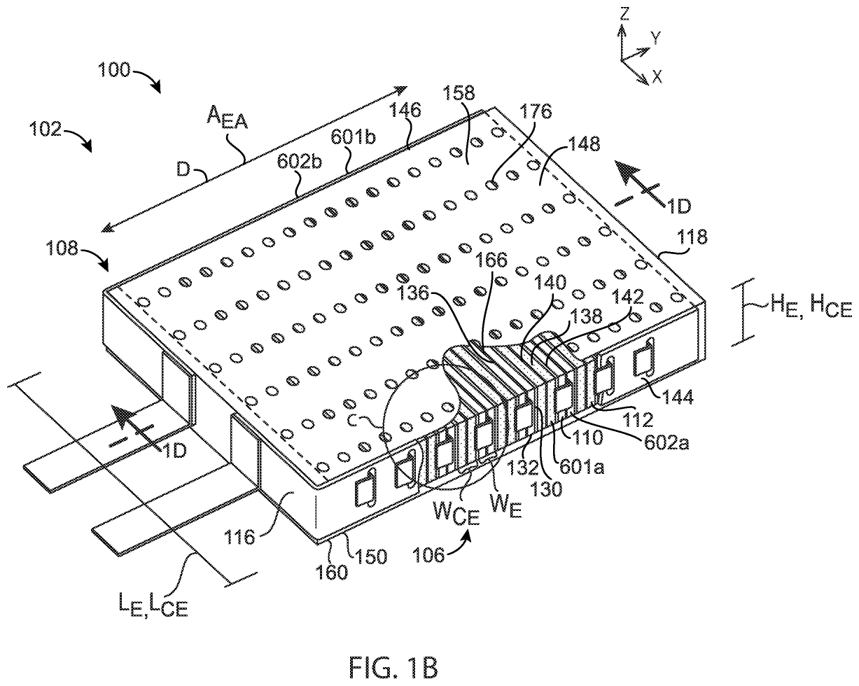

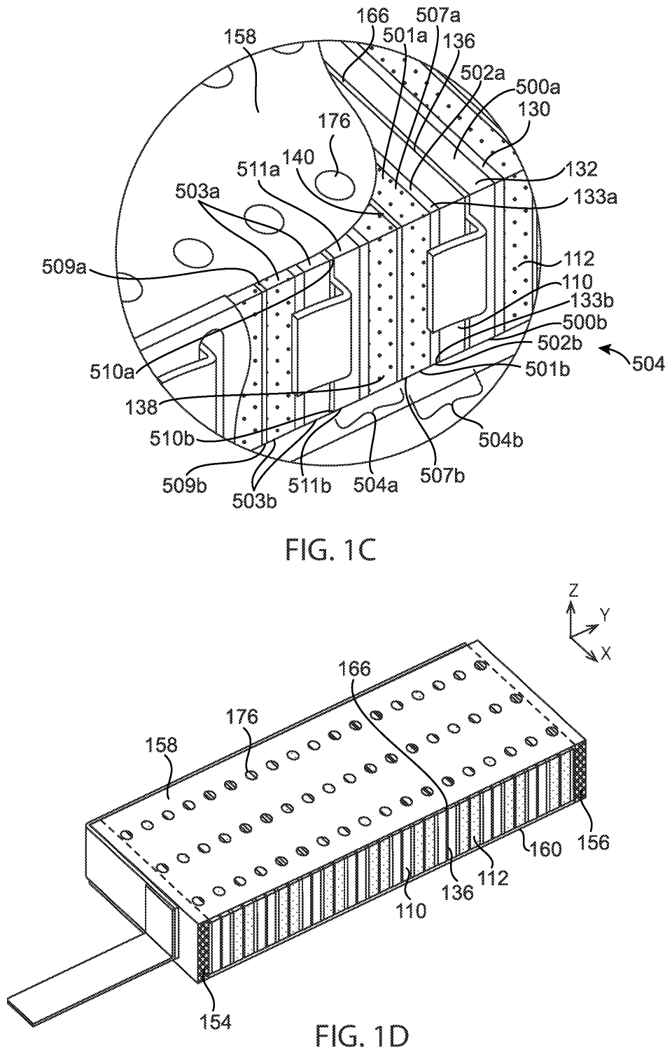

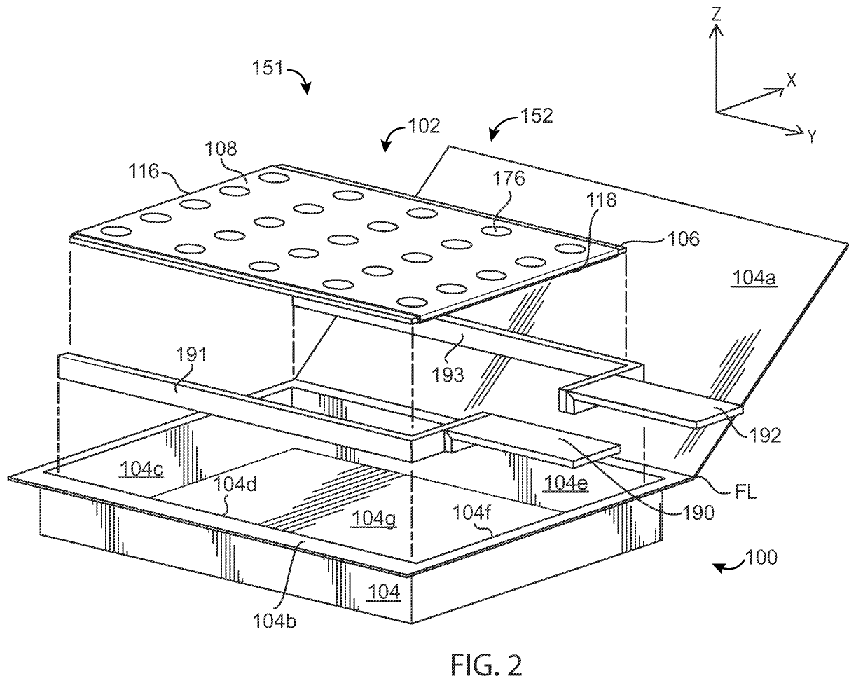

In general, the present disclosure is directed to an energy storage device 100, such as a secondary battery 102, as shown for example in FIGS. 1A-1D and 2, that cycles between a charged state and a discharged state. The secondary battery 102 includes a battery enclosure 104, an electrode assembly 106, carrier ions, and a non-aqueous liquid electrolyte within the battery enclosure 104. In certain embodiments, the secondary battery 102 also includes a constraint system 108 that restrains growth of the electrode assembly 106. The growth of the electrode assembly 106 that is being constrained may be a macroscopic increase in one or more dimensions of the electrode assembly 106.

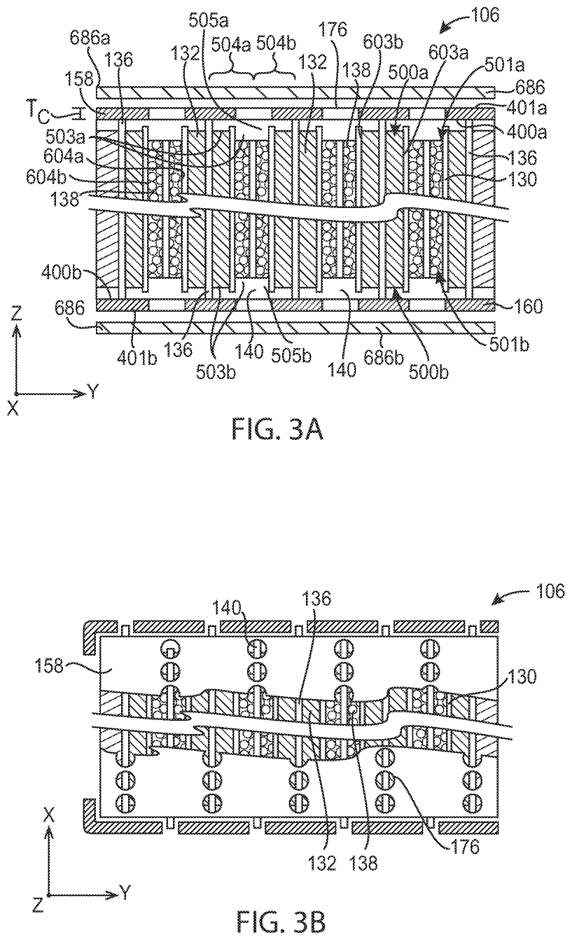

According to embodiments of the present disclosure, a method is provided for the transfer of carrier ions from an auxiliary electrode 686 comprising a source of carrier ions to the electrode assembly 106, as shown for example in FIG. 3A. As discussed in further detail herein, according to certain embodiments, the transfer of carrier ions is performed as a part of an initial formation process performed to activate a secondary battery comprising the electrode assembly. According to other embodiments, the transfer of carrier ions is performed as a part of a process to replenish carrier ions in the electrode assembly that are lost due to formation of a solid electrolyte interphase (SEI) during an initial formation process and/or during cycling between charged and discharged states.

Referring again to FIGS. 1A-1D, in one embodiment, the electrode assembly 106 includes a population of unit cells 504 stacked in series in a stacking direction (i.e. stacking direction D in FIG. 1B). Each member of the unit cell population comprises an electrode structure 110, a counter-electrode structure 112, and an electrically insulating separator 130 between the electrode and counter-electrode structures, to electrically insulate the electrode and counter-electrode structures 110, 112 from one another. In one example, as shown in FIG. 1B, the electrode assembly comprises a series of stacked unit cells 504 comprising the electrode structures 110 and counter-electrode structures in an alternating arrangement. FIG. 1C is an inset showing the secondary battery with electrode assembly 106 of FIG. 1B, and FIG. 1D is a cross-section of the secondary battery with electrode assembly 106 of FIG. 1B. Other arrangements of the stacked series of unit cells 504a, 504b, can also be provided.

In one embodiment, the electrode structures 110 comprise an electrode active material layer 132, and an electrode current collector 136, as shown for example in FIGS. 1A-1D. For example, the electrode structure 110 can comprise an electrode current collector 136 disposed between one or more electrode active material layers 132. According to one embodiment, the electrode active material layer 132 comprises an anode active material, and the electrode current collector 136 comprises an anode current collector. Similarly, in one embodiment, the counter-electrode structure 112 comprises a counter-electrode active material layer 138, and a counter-electrode current collector 140. For example, the counter-electrode structure 112 can comprise a counter-electrode current collector 140 disposed between one or more counter-electrode active material layers 138. According to one embodiment, the counter-electrode active material layer 138 comprises a cathode active material, and the counter-electrode current collector 140 comprises a cathode current collector. Furthermore, it should be understood that the electrode and counter-electrode structures 110, 112, respectively, are not limited to the specific embodiments and structures described herein, and other configurations, structures, and/or materials other than those specifically described herein can also be provided to form the electrode structures 110 and counter-electrode structures 112. According to certain embodiments, each unit cell 504a, 504b in the unit cell population comprises, in the stacked series, a unit cell portion of the electrode current collector 136, an electrode structure 110 comprising an electrode active material layer 132, an electrically insulating separator 130 between the electrode and counter-electrode active material layers, a counter-electrode structure 112 comprising a counter-electrode active material layer 138, and a unit cell portion of a counter-electrode current collector 140. In certain embodiments, the order of the unit cell portion of the electrode current collector, electrode active material layer, separator, counter-electrode active material layer, and the unit cell portion of the counter-electrode current collector will be reversed for unit cells that are adjacent to one another in the stacked series, with portions of the electrode current collector and/or counter-electrode current collector being shared between adjacent unit cells, as shown for example in FIG. 1C.

According to the embodiment as shown in FIGS. 1A-1D, the members of the electrode and counter-electrode structure populations 110, 112, respectively, are arranged in alternating sequence, with a direction of the alternating sequence corresponding to the stacking direction D. The electrode assembly 106 according to this embodiment further comprises mutually perpendicular longitudinal, transverse, and vertical axes, with the longitudinal axis A_{EA} generally corresponding or parallel to the stacking direction D of the members of the electrode and counter-electrode structure populations. As shown in the embodiment in FIG. 1B, the longitudinal axis A_{EA} is depicted as corresponding to the Y axis, the transverse axis is depicted as corresponding to the X axis, and the vertical axis is depicted as corresponding to the Z axis.

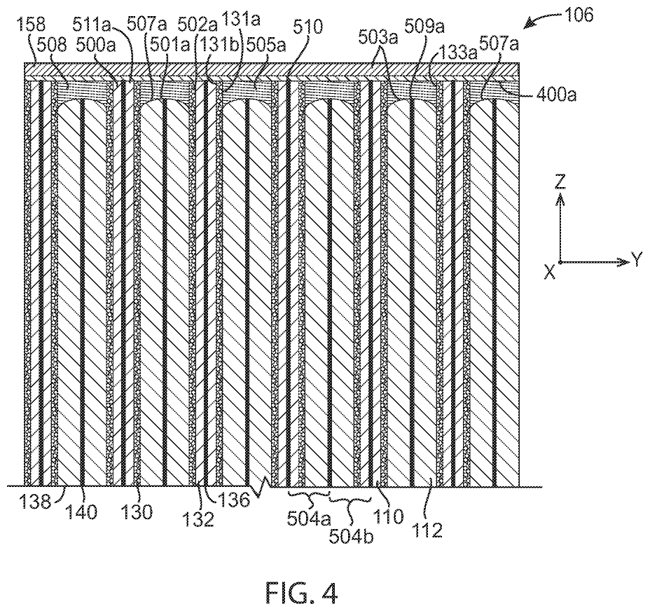

According to embodiments of the disclosure herein, the electrode structures 110, counter-electrode structures 112 and electrically insulating separators 130 within each unit cell 504 of the unit cell population have opposing upper and lower end surfaces separated in a vertical direction that is orthogonal to the stacking direction of the unit cell population. For example, referring to FIGS. 1C and 4, the electrode structures 110 in each member of the unit cell population can comprise opposing upper and lower end surfaces 500a, 500b separated in the vertical direction, the counter-electrode structures 112 in each member of the unit cell population can comprise opposing upper and lower end surfaces 501a, 501b separated in the vertical direction, and the electrically insulating separator 130 can comprise opposing upper and lower end surfaces 502a, 502b separated in the vertical direction. According to yet another embodiment, members of the unit cell population have upper and lower edge margins 503a, 503b that extend across and comprise the opposing upper and lower end surfaces of the electrode structure 110, electrically insulating separator 130 and counter-electrode structure 112 within each unit cell member. Referring to FIGS. 3A and 4, according to yet another embodiment upper end surfaces 500a, 501a of the electrode and counter-electrode structures 110, 112 within a same unit cell population member are vertically offset from one another to form an upper recess 505a, and lower end surfaces 500b, 501b of the electrode and counter-electrode structures 110, 112 within a same unit cell population member are vertically offset from one another to form a lower recess 505b. For example, the counter-electrode upper and lower end surfaces can be recessed and/or offset inwardly with respect to the respective electrode upper and lower end surfaces within the same unit cell population member. Referring to FIG. 3A, in one embodiment, members of the unit cell population comprise a counter-electrode active material layer 138 that has upper and lower end surfaces 501a, 501b that are recessed inwardly with respect to the upper and lower end surfaces of the electrode active material layer 132 and/or the electrically insulating separator 130.

In one embodiment, the electrode assembly 106 is enclosed within a volume V defined by the constraint system 108 that restrains overall macroscopic growth of the electrode assembly 106, as illustrated for example in FIGS. 1A and 1B. The constraint system 108 may be capable of restraining growth of the electrode assembly 106 along one or more dimensions, such as to reduce swelling and deformation of the electrode assembly 106, and thereby improve the reliability and cycling lifetime of an energy storage device 100 having the constraint system 108. Without being limited to any one particular theory, it is believed that carrier ions traveling between the electrode structures 110 and counter-electrode structures 112 during charging and/or discharging of a secondary battery 102 and/or electrode assembly can become inserted into electrode active material, causing the electrode active material and/or the electrode structure 110 to expand. This expansion of the electrode structure 110 can cause the electrodes and/or electrode assembly 106 to deform and swell, thereby compromising the structural integrity of the electrode assembly 106, and/or increasing the likelihood of electrical shorting or other failures. In one example, excessive swelling and/or expansion and contraction of the electrode active material layer 132 during cycling of an energy storage device 100 can cause fragments of electrode active material to break away and/or delaminate from the electrode active material layer 132, thereby compromising the efficiency and cycling lifetime of the energy storage device 100. In yet another example, excessive swelling and/or expansion and contraction of the electrode active material layer 132 can cause electrode active material to breach the electrically insulating microporous separator 130, thereby causing electrical shorting and other failures of the electrode assembly 106. Accordingly, the constraint system 108 inhibits this swelling or growth that can otherwise occur with cycling between charged and discharged states to improve the reliability, efficiency, and/or cycling lifetime of the energy storage device 100.

in one embodiment, a constraint system 108 comprising a primary growth constraint system 151 is provided to mitigate and/or reduce at least one of growth, expansion, and/or swelling of the electrode assembly 106 in the longitudinal direction (i.e., in a direction that parallels the Y axis), as shown for example in FIG. 1A. For example, the primary growth constraint system 151 can include structures configured to constrain growth by opposing expansion at longitudinal end surfaces 116, 118 of the electrode assembly 106. In one embodiment, the primary growth constraint system 151 comprises first and second primary growth constraints 154, 156, that are separated from each other in the longitudinal direction (stacking direction), and that can operate in conjunction with at least one primary connecting member 162 that connects the first and second primary growth constraints 154, 156 together to restrain growth in the electrode assembly 106 in the stacking direction. For example, the first and second primary growth constraints 154, 156 may at least partially cover first and second longitudinal end surfaces 116, 118 of the electrode assembly 106, and may operate in conjunction with connecting members 162, 164 connecting the first and second primary growth constraints 154, 156 to one another to oppose and restrain any growth in the electrode assembly 106 that occurs during repeated cycles of charging and/or discharging.

In addition, repeated cycling through charge and discharge processes in a secondary battery 102 can induce growth and strain not only in a longitudinal direction of the electrode assembly 106 (e.g., Y-axis in FIG. 1A), but can also induce growth and strain in directions orthogonal to the longitudinal direction, as discussed above, such as the transverse and vertical directions (e.g., X and Z axes, respectively, in FIG. 1A). Furthermore, in certain embodiments, the incorporation of a primary growth constraint system 151 to inhibit growth in one direction can even exacerbate growth and/or swelling in one or more other directions. For example, in a case where the primary growth constraint system 151 is provided to restrain growth of the electrode assembly 106 in the longitudinal direction, the intercalation of carrier ions during cycles of charging and discharging and the resulting swelling of electrode structures can induce strain in one or more other directions. In particular, in one embodiment, the strain generated by the combination of electrode growth/swelling and longitudinal growth constraints can result in buckling or other failure(s) of the electrode assembly 106 in the vertical direction (e.g., the Z axis as shown in FIG. 1A), or even in the transverse direction (e.g., the X axis as shown in FIG. 1A). Accordingly, in one embodiment of the present disclosure, a secondary growth constraint system 152 is provided that may operate in conjunction with the primary growth constraint system 151 to restrain growth of the electrode assembly 106 along multiple axes of the electrode assembly 106. For example, in one embodiment, the secondary growth constraint system 152 may be configured to interlock with, or otherwise synergistically operate with, the primary growth constraint system 151, such that overall growth of the electrode assembly 106 can be restrained to impart improved performance and reduced incidence of failure of the secondary battery having the electrode assembly 106 and primary and secondary growth constraint systems 151 and 152, respectively.

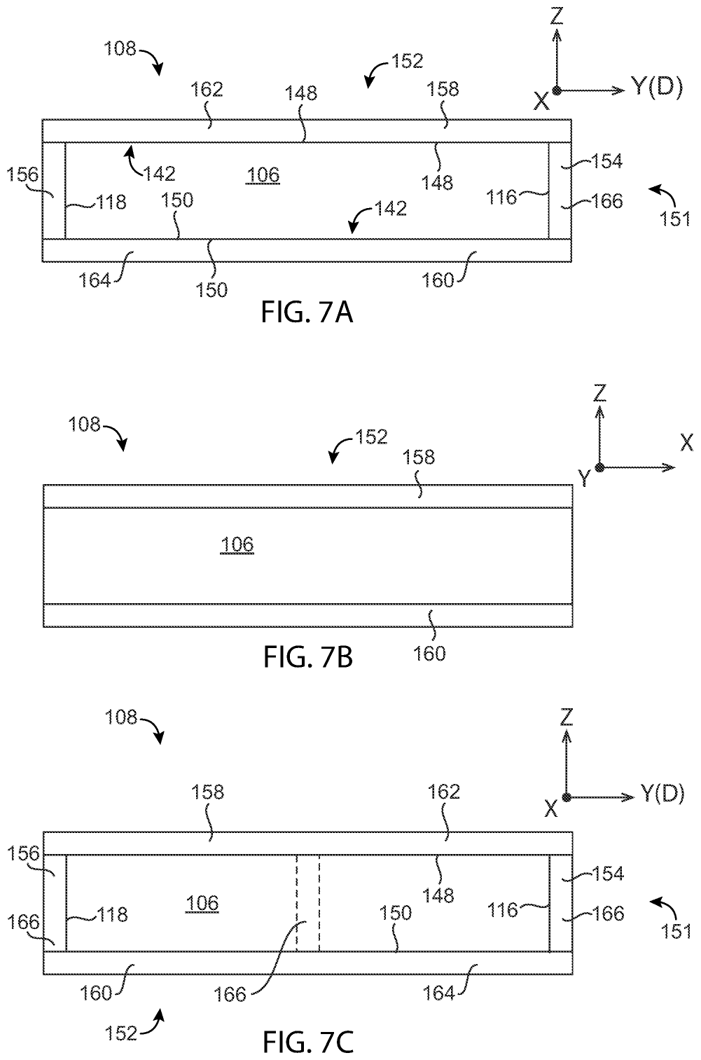

Referring to FIGS. 7A-7C, an embodiment of a constraint system 108 is shown having the primary growth constraint system 151 and the secondary growth constraint system 152 for an electrode assembly 106. FIG. 7A shows a cross-section of the electrode assembly 106 in FIG. 1A taken along the longitudinal axis (Y axis), such that the resulting 2-D cross-section is illustrated with the vertical axis (Z axis) and longitudinal axis (Y axis). FIG. 7B shows a cross-section of the electrode assembly 106 in FIG. 1A taken along the transverse axis (X axis), such that the resulting 2-D cross-section is illustrated with the vertical axis (Z axis) and transverse axis (X axis). As shown in FIG. 7A, the primary growth constraint system 151 can generally comprise first and second primary growth constraints 154, 156, respectively, that are separated from one another along the longitudinal direction (Y axis). For example, in one embodiment, the first and second primary growth constraints 154, 156, respectively, comprise a first primary growth constraint 154 that at least partially or even entirely covers a first longitudinal end surface 116 of the electrode assembly 106, and a second primary growth constraint 156 that at least partially or even entirely covers a second longitudinal end surface 118 of the electrode assembly 106. In yet another version, one or more of the first and second primary growth constraints 154, 156 may be interior to the longitudinal end surfaces 116, 118 of the electrode assembly 106, such as when one or more of the primary growth constraints comprise an internal structure of the electrode assembly 106. The primary growth constraint system 151 can further comprise at least one primary connecting member 162 that connects the first and second primary growth constraints 154, 156, and that may have a principal axis that is parallel to the longitudinal direction. For example, the primary growth constraint system 151 can comprise first and second primary connecting members 162, 164, respectively, that are separated from each other along an axis that is orthogonal to the longitudinal axis, such as along the vertical axis (Z axis) as depicted in the embodiment. The first and second primary connecting members 162, 164, respectively, can serve to connect the first and second primary growth constraints 154, 156, respectively, to one another, and to maintain the first and second primary growth constraints 154, 156, respectively, in tension with one another, so as to restrain growth along the longitudinal axis of the electrode assembly 106.

Further shown in FIGS. 7A-7C, the constraint system 108 can further comprise the secondary growth constraint system 152, that can generally comprise first and second secondary growth constraints 158, 160, respectively, that are separated from one another along a second direction orthogonal to the longitudinal direction, such as along the vertical axis (Z axis) in the embodiment as shown. For example, in one embodiment, the first secondary growth constraint 158 at least partially extends across a first region 148 of the lateral surface 142 of the electrode assembly 106, and the second secondary growth constraint 160 at least partially extends across a second region 150 of the lateral surface 142 of the electrode assembly 106 that opposes the first region 148. In yet another version, one or more of the first and second secondary growth constraints 158, 160 may be interior to the lateral surface 142 of the electrode assembly 106, such as when one or more of the secondary growth constraints comprise an internal structure of the electrode assembly 106. In one embodiment, the first and second secondary growth constraints 158, 160, respectively, are connected by at least one secondary connecting member 166, which may have a principal axis that is parallel to the second direction, such as the vertical axis. The secondary connecting member 166 may serve to connect and hold the first and second secondary growth constraints 158, 160, respectively, in tension with one another, so as to restrain growth of the electrode assembly 106 along a direction orthogonal to the longitudinal direction, such as for example to restrain growth in the vertical direction (e.g., along the Z axis). In the embodiment depicted in FIG. 7A, the at least one secondary connecting member 166 can correspond to at least one of the first and second primary growth constraints 154, 156. However, the secondary connecting member 166 is not limited thereto, and can alternatively and/or in addition comprise other structures and/or configurations.

According to one embodiment, the primary and secondary growth constraint systems 151, 152, respectively, are configured to cooperatively operate such that portions of the primary growth constraint system 151 cooperatively act as a part of the secondary growth constraint system 152, and/or portions of the secondary growth constraint system 152 cooperatively act as a part of the primary growth constraint system 151. For example, in the embodiment shown in in FIGS. 7A and 7B, the first and second primary connecting members 162, 164, respectively, of the primary growth constraint system 151 can serve as at least a portion of, or even the entire structure of, the first and second secondary growth constraints 158, 160 that constrain growth in the second direction orthogonal to the longitudinal direction. In yet another embodiment, as mentioned above, one or more of the first and second primary growth constraints 154, 156, respectively, can serve as one or more secondary connecting members 166 to connect the first and second secondary growth constrains 158, 160, respectively. Conversely, at least a portion of the first and second secondary growth constraints 158, 160, respectively, can act as first and second primary connecting members 162, 164, respectively, of the primary growth constraint system 151, and the at least one secondary connecting member 166 of the secondary growth constraint system 152 can, in one embodiment, act as one or more of the first and second primary growth constraints 154, 156, respectively. Accordingly, the primary and secondary growth constraint systems 151, 152, respectively, can share components and/or structures to exert restraint on the growth of the electrode assembly 106.

In one embodiment, the constraint system 108 can comprise structures such as the primary and secondary growth constraints, and primary and secondary connecting members, that are structures that are external to and/or internal to the battery enclosure 104, or may be a part of the battery enclosure 104 itself. In certain embodiments, the battery enclosure 104 may be a sealed enclosure, for example to seal liquid electrolyte therein, and/or to seal the electrode assembly 106 from the external environment. In one embodiment, the constraint system 108 can comprise a combination of structures that includes the battery enclosure 104 as well as other structural components. In one such embodiment, the battery enclosure 104 may be a component of the primary growth constraint system 151 and/or the secondary growth constraint system 152; stated differently, in one embodiment, the battery enclosure 104, alone or in combination with one or more other structures (within and/or outside the battery enclosure 104, for example, the primary growth constraint system 151 and/or a secondary growth constraint system 152) restrains growth of the electrode assembly 106 in the electrode stacking direction D and/or in the second direction orthogonal to the stacking direction, D. In one embodiment, one or more of the primary growth constraints 154, 156 and secondary growth constraints 158, 160 can comprise a structure that is internal to the electrode assembly. In another embodiment, the primary growth constraint system 151 and/or secondary growth constraint system 152 do not form any part of the battery enclosure 104, and instead one or more discrete structures (within and/or outside the battery enclosure 104) other than the battery enclosure 104 restrains growth of the electrode assembly 106 in the electrode stacking direction, D, and/or in the second direction orthogonal to the stacking direction, D. In another embodiment, the primary and secondary growth constraint systems 151, 152 are within the battery enclosure 104, which may be a sealed battery enclosure, such as a hermetically sealed battery enclosure. The electrode assembly 106 may be restrained by the constraint system 108 at a pressure that is greater than the pressure exerted by growth and/or swelling of the electrode assembly 106 during repeated cycling of an energy storage device 100 or a secondary battery having the electrode assembly 106.

In one exemplary embodiment, the primary growth constraint system 151 includes one or more discrete structure(s) within the battery enclosure 104 that restrains growth of the electrode structure 110 in the stacking direction D by exerting a pressure that exceeds the pressure generated by the electrode structure 110 in the stacking direction D upon repeated cycling of a secondary battery 102 having the electrode structure 110 as a part of the electrode assembly 106. In another exemplary embodiment, the primary growth constraint system 151 includes one or more discrete structures within the battery enclosure 104 that restrains growth of the counter-electrode structure 112 in the stacking direction D by exerting a pressure in the stacking direction D that exceeds the pressure generated by the counter-electrode structure 112 in the stacking direction D upon repeated cycling of a secondary battery 102 having the counter-electrode structure 112 as a part of the electrode assembly 106. The secondary growth constraint system 152 can similarly include one or more discrete structures within the battery enclosure 104 that restrain growth of at least one of the electrode structures 110 and counter-electrode structures 112 in the second direction orthogonal to the stacking direction D, such as along the vertical axis (Z axis), by exerting a pressure in the second direction that exceeds the pressure generated by the electrode or counter-electrode structure 110, 112, respectively, in the second direction upon repeated cycling of a secondary battery 102 having the electrode or counter-electrode structures 110, 112, respectively.

In yet another embodiment, the first and second primary growth constraints 154, 156, respectively, of the primary growth constraint system 151 restrain growth of the electrode assembly 106 by exerting a pressure on the first and second longitudinal end surfaces 116, 118 of the electrode assembly 106, meaning, in a longitudinal direction, that exceeds a pressure exerted by the first and second primary growth constraints 154, 156 on other surfaces of the electrode assembly 106 that would be in a direction orthogonal to the longitudinal direction, such as opposing first and second regions of the lateral surface 142 of the electrode assembly 106 along the transverse axis and/or vertical axis. That is, the first and second primary growth constraints 154, 156 may exert a pressure in a longitudinal direction (Y axis) that exceeds a pressure generated thereby in directions orthogonal thereto, such as the transverse (X axis) and vertical (Z axis) directions. For example, in one such embodiment, the primary growth constraint system 151 restrains growth of the electrode assembly 106 with a pressure on first and second longitudinal end surfaces 116, 118 (i.e., in the stacking direction D) that exceeds the pressure maintained on the electrode assembly 106 by the primary growth constraint system 151 in at least one, or even both, of the two directions that are perpendicular to the stacking direction D, by a factor of at least 3. By way of further example, in one such embodiment, the primary growth constraint system 151 restrains growth of the electrode assembly 106 with a pressure on first and second longitudinal end surfaces 116, 118 (i.e., in the stacking direction D) that exceeds the pressure maintained on the electrode assembly 106 by the primary growth constraint system 151 in at least one, or even both, of the two directions that are perpendicular to the stacking direction D by a factor of at least 4. By way of further example, in one such embodiment, the primary growth constraint system 151 restrains growth of the electrode assembly 106 with a pressure on first and second longitudinal end surfaces 116, 118 (i.e., in the stacking direction D) that exceeds the pressure maintained on the electrode assembly 106 in at least one, or even both, of the two directions that are perpendicular to the stacking direction D, by a factor of at least 5.

Referring now to FIG. 7C, an embodiment of an electrode assembly 106 with a constraint system 108 is shown, with a cross-section taken along the line A-A′ as shown in FIG. 1A. In the embodiment shown in FIG. 7C, the primary growth constraint system 151 can comprise first and second primary growth constraints 154, 156, respectively, at the longitudinal end surfaces 116, 118 of the electrode assembly 106, and the secondary growth constraint system 152 comprises first and second secondary growth constraints 158, 160 at the opposing first and second surface regions 148, 150 of the lateral surface 142 of the electrode assembly 106. According to this embodiment, the first and second primary growth constraints 154, 156 can serve as the at least one secondary connecting member 166 to connect the first and second secondary growth constrains 158, 160 and maintain the growth constraints in tension with one another in the second direction (e.g., vertical direction) that is orthogonal to the longitudinal direction. However, additionally and/or alternatively, the secondary growth constraint system 152 can comprise at least one secondary connecting member 166 that is located at a region other than the longitudinal end surfaces 116, 118 of the electrode assembly 106. Also, the at least one secondary connecting member 166 can be understood to act as at least one of a first and second primary growth constraint 154, 156 that is internal to the longitudinal ends 116, 118 of the electrode assembly, and that can act in conjunction with either another internal primary growth restraint and/or a primary growth restraint at a longitudinal end 116, 118 of the electrode assembly 106 to restrain growth. Referring to the embodiment shown in FIG. 7C, a secondary connecting member 166 can be provided that is spaced apart along the longitudinal axis away from the first and second longitudinal end surfaces 116, 118, respectively, of the electrode assembly 106, such as toward a central region of the electrode assembly 106. The secondary connecting member 166 can connect the first and second secondary growth constraints 158, 160, respectively, at an interior position from the electrode assembly end surfaces 116, 118, and may be under tension between the secondary growth constraints 158, 160 at that position. In one embodiment, the secondary connecting member 166 that connects the secondary growth constraints 158, 160 at an interior position from the end surfaces 116, 118 is provided in addition to one or more secondary connecting members 166 provided at the electrode assembly end surfaces 116, 118, such as the secondary connecting members 166 that also serve as primary growth constraints 154, 156 at the longitudinal end surfaces 116, 118. In another embodiment, the secondary growth constraint system 152 comprises one or more secondary connecting members 166 that connect with first and second secondary growth constraints 158, 160, respectively, at interior positions that are spaced apart from the longitudinal end surfaces 116, 118, with or without secondary connecting members 166 at the longitudinal end surfaces 116, 118. The interior secondary connecting members 166 can also be understood to act as first and second primary growth constraints 154, 156, according to one embodiment. For example, in one embodiment, at least one of the interior secondary connecting members 166 can comprise at least a portion of an electrode or counter-electrode structure 110, 112, as described in further detail below.

More specifically, with respect to the embodiment shown in FIG. 7C, the secondary growth constraint system 152 may include a first secondary growth constraint 158 that overlies an upper region 148 of the lateral surface 142 of electrode assembly 106, and an opposing second secondary growth constraint 160 that overlies a lower region 150 of the lateral surface 142 of electrode assembly 106, the first and second secondary growth constraints 158, 160 being separated from each other in the vertical direction (i.e., along the Z-axis). Additionally, secondary growth constraint system 152 may further include at least one interior secondary connecting member 166 that is spaced apart from the longitudinal end surfaces 116, 118 of the electrode assembly 106. The interior secondary connecting member 166 may be aligned parallel to the Z axis and connects the first and second secondary growth constraints 158, 160, respectively, to maintain the growth constraints in tension with one another, and to form at least a portion of the secondary growth constraint system 152. In one embodiment, the at least one interior secondary connecting member 166, either alone or with secondary connecting members 166 located at the longitudinal end surfaces 116, 118 of the electrode assembly 106, may be under tension between the first and secondary growth constraints 158, 160 in the vertical direction (i.e., along the Z axis), during repeated charge and/or discharge of an energy storage device 100 and/or a secondary battery 102 having the electrode assembly 106, to reduce growth of the electrode assembly 106 in the vertical direction. Furthermore, in the embodiment as shown in FIG. 7C, the constraint system 108 further comprises a primary growth constraint system 151 having first and second primary growth constraints 154, 156, respectively, at the longitudinal ends 116, 118 of the electrode assembly 106, that are connected by first and second primary connecting members 162, 164, respectively, at the upper and lower lateral surface regions 148, 150, respectively, of the electrode assembly 106. In one embodiment, the secondary interior connecting member 166 can itself be understood as acting in concert with one or more of the first and second primary growth constraints 154, 156, respectively, to exert a constraining pressure on each portion of the electrode assembly 106 lying in the longitudinal direction between the secondary interior connecting member 166 and the longitudinal ends 116, 118 of the electrode assembly 106 where the first and second primary growth constraints 154, 156, respectively, can be located.

According to one embodiment, the first and second secondary growth constraints 158, 160, respectively, are connected to a secondary connecting member 166 that comprises at least a portion of an electrode 110 or counter-electrode 112 structure, or other interior structure of the electrode assembly 106. In one embodiment, the first secondary growth constraint 158 is connected to the upper end surface(s) 500a, 501a of the electrode and/or counter-electrode structures 110, 112 of a subset 510 of members of the unit cell population 504. In another embodiment, the second secondary growth constraint 160 is connected to the lower end surface(s) 500b, 501b of the electrode or counter-electrode structures 110, 112 of a subset 501 of members of the unit cell population 504. The subset of the unit cell members that are connected at the upper end surface(s) may be the same as the subset of unit cell members that are connected at the lower end surface(s), or may be different subsets. In one embodiment, the first and/or second secondary growth constraints 158, 160, can be connected to other interior structures in the electrode assembly forming the secondary connecting member 166. In one embodiment, the first and second secondary growth constraints may be connected to upper and/or lower end surfaces of structures of electrode and/or counter-electrodes structures including one or more of the electrode current collector, electrode active material layer, counter-electrode current collector and counter-electrode active material layer, in members of the unit cell population. In another example, the first and second secondary growth constraints can be connected to upper and/or lower end surfaces of the electrically insulating separator. Accordingly, the secondary connecting member 166 can comprise, in certain embodiments, one or more of the electrode and/or counter-electrodes structures including one or more of the electrode current collector, electrode active material layer, counter-electrode current collector and counter-electrode active material layer, in members of the unit cell population. Referring to FIGS. 3A-3B, embodiments are shown in which the first and second secondary growth constraints 158, 160 are connected to secondary connecting members 166 comprising the electrode current collectors 136 of subsets of members of the unit cell population. In FIG. 4, the first and second secondary growth constraints 158, 160 are connected to secondary connecting members 166 comprising electrode structures 110 including the electrode current collectors 136.

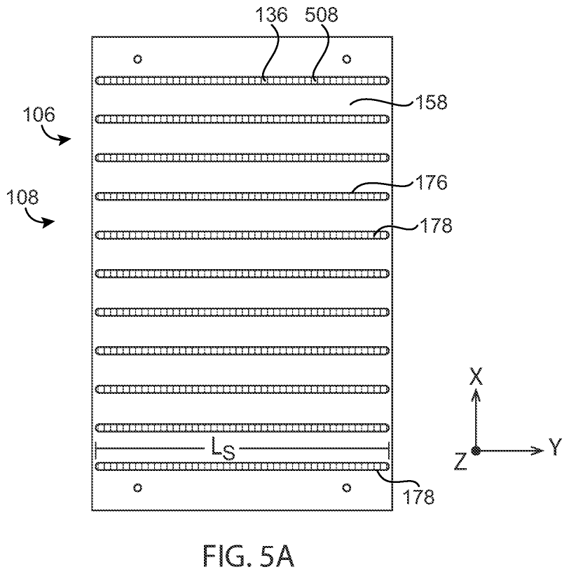

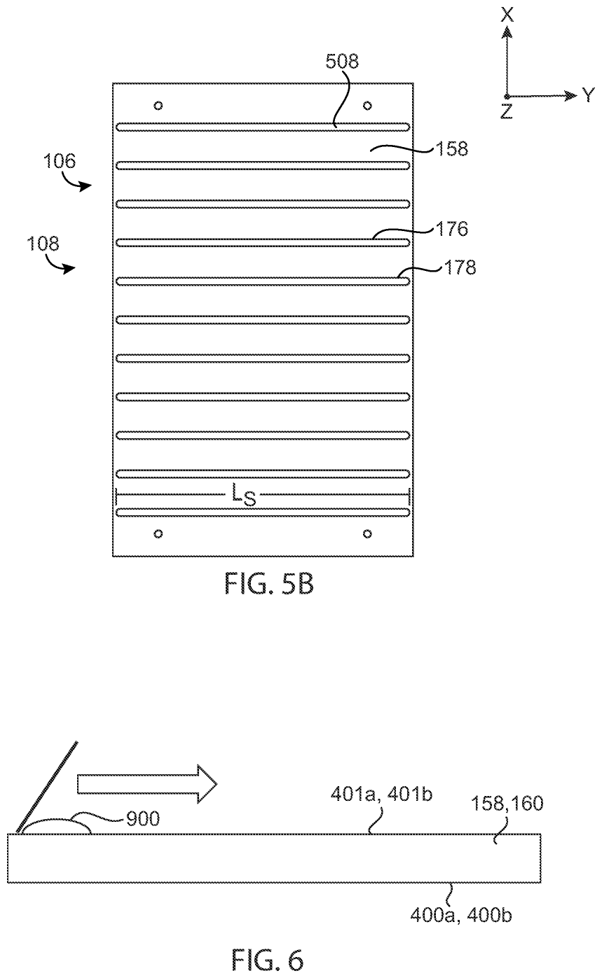

Referring to FIGS. 3A-3B, in one embodiment, the first and/or second secondary growth constraints 158, 160 comprise apertures 176 formed through respective vertical thicknesses T_{C} thereof. According to embodiments herein, the apertures 176 can provide passages for the flow of carrier ions from the auxiliary electrode 686 through the first and/or second secondary growth constraints 158, 160 and to members of the unit cell population. For example, for an auxiliary electrode 686 located outside the volume V enclosed by the constraint system 108, e.g. positioned externally to the first and/or second secondary growth constraints 158, 160, the carrier ions provided from the auxiliary electrode 686 can access the unit cell member of the electrode assembly inside the constraints, via passage through the apertures 176. In the embodiment shown in FIGS. 5A-5B, which depict a top view of electrode assembly 106 showing the first secondary growth constraint 158, the apertures 176 comprise a slot-shape with the elongated dimension oriented in the longitudinal and/or stacking direction (Y-direction), and which extends across a plurality of unit cell members. Other shapes and/or configurations of the apertures 176 may also be provided. For example, in one embodiment, the plurality of apertures comprise a plurality of slots 178 spaced apart from one another in a transverse direction that is orthogonal to the stacking direction and the vertical direction, each slot 178 having a longitudinal axis L_{S} oriented in the stacking direction, and wherein each slot extends across a plurality of members of the unit cell population.

According to certain embodiments, the electrode assembly 106 further comprises a porous electrically insulating material 508 disposed within the plurality of apertures 176, as shown for example in FIG. 5B. According to certain embodiments, the porous electrically insulating material has a porosity in the range of from 20% to 60% (percent of pore volume per total volume of porous electrically insulating material). The porous electrically insulating material 508 is, according to certain embodiments, capable of providing an ion conducting structure, and can provide a path for carrier ions provided by an auxiliary electrode to members of the unit cell population. In one embodiment, processes to transfer carrier ions from the auxiliary electrode 686 to the unit cell members can comprise, according to certain embodiments, transferring carrier ions from the auxiliary electrode 686 via the apertures 176 and through the porous electrically insulating material 508 disposed in the apertures 176, to one or more of the electrode and counter-electrode structures 110, 112. According to one embodiment, the apertures 176, such as the slots 178, are substantially filled with the porous electrically insulating material 508. According to yet another embodiment, the porous electrically insulating material substantially fills any apertures in the first and/or second secondary growth constraints that form a portion of the path for the carrier ions from the auxiliary electrode 686 to members of the unit cell population 504. In one embodiment, substantially all of the apertures 176 are filled with the porous electrically insulating material 508 throughout the vertical thickness thereof, as shown in FIG. 5B. In another embodiment, only those apertures 176 forming a part of the ion transfer path to the unit cell members are filled with the porous electrically insulating material.

According to one embodiment, the electrode assembly 106 further comprises porous electrically insulating material 508 covering the upper and/or lower end surface(s) 500a, 500b, 501a, 501b of the electrode and/or counter-electrode structure(s) 110, 112 of the members of the unit cell population 504. For example, as shown in FIGS. 3A and 4, the porous electrically insulating material 508 may be located within one or more of the upper and lower recesses 505a, 505b formed by the vertical offset of electrode and counter-electrode structures within the unit cell members. According to certain embodiments, the porous electrically insulating material has a porosity in the range of from 20% to 60% (percent of pore volume per total volume of porous electrically insulating material). The porous electrically insulating material 508 is, according to certain embodiments, capable of providing an ion conducting structure, and can provide a further path for carrier ions provided by an auxiliary electrode through the porous electrically insulating material disposed in the apertures 176 to members of the unit cell population. According to one embodiment, the porous electrically insulating material disposed in the apertures 176 of the first and/or second secondary growth constraints, and the porous electrically insulating material 508 provided on the upper and/or lower end surface(s) 500a, 500b, 501a, 501b of the electrode and/or counter-electrode structure(s) 110, 112, can provide a substantially continuous ion-conducting path for transfer of carrier ions from the auxiliary electrode 686 to the unit cell members.

According to certain embodiments, at least a portion of the apertures 176 having the porous electrically insulating material disposed therein, is aligned over the porous electrically insulating material 508 provided on the upper and/or lower end surface(s) 500a, 500b, 501a, 501b of the electrode and/or counter-electrode structure(s) 110, 112 in the vertical direction, such that carrier ions entering the electrode assembly 106 through the apertures 176 pass through the porous electrically insulating material 508 in the apertures 176 and covering the upper and/or lower end surface(s) of the electrode and/or counter-electrode structure(s) to reach the members of the unit cell population. Processes to transfer carrier ions from the auxiliary electrode 686 to the unit cell members can comprise, according to certain embodiments, transferring carrier ions from the auxiliary electrode 686 via the apertures 176 and through the porous electrically insulating material 508 forming the ion conducting pathway to one or more of the electrode and counter-electrode structures 110, 112. In the embodiment as shown in FIG. 5B, which depicts the electrode assembly and constraint system having the porous electrically insulating material disposed in the constraint apertures 176, the porous electrically insulating material 508 substantially fills the apertures 176 of the first and/or second secondary constraints 158, 160, externally to the upper and/or lower end surfaces of the electrode and counter-electrode structures 110, 112. In the embodiment as shown in FIG. 5A, which depicts the electrode assembly and constraint system 108 without any porous electrically insulating material disposed in the constraint apertures 176 (e.g., before porous electrically insulating material has been disposed in the constraint apertures 176) the porous electrically insulating material 508 further extends over the upper and lower end surfaces of the electrode and counter-electrode structures, within the confines of the first and second secondary growth constraints. In the embodiment as shown in FIG. 5A, the porous electrically insulating material 508 covers upper and lower end surfaces of the electrode and counter-electrode structures, with the upper and lower end surfaces of the electrode current collectors 136 remaining exposed. In FIG. 5B, the porous electrically insulating material 508 is provided to the apertures 176 in the constraint system 108, covering the upper and lower end surfaces of the electrode current collectors 136 below the apertures 176. The porous electrically insulating material 508 can, in certain embodiments, form a substantially continuous ion-conducting structure substantially filling the apertures 176, and substantially filling any space within the volume V enclosed by the constraint system that is between the upper and lower end surfaces 500a, 500b, 501a, 501c of the electrode and counter-electrode structures 110, 112, and upper and lower inner surfaces 400a, 400b of the first and second secondary growth constraints, including by filling the upper and lower recesses 505a, 505b.

Referring FIG. 4, according to one embodiment, the porous electrically insulating material 508 substantially fills the upper and lower recesses 505a, 505b of members of the unit cell population 504. According to yet another embodiment, the porous electrically insulating material 508 is disposed such that at least a portion of the porous electrically insulating material 508 covering the upper and/or lower end surfaces 500a, 500b, 501a, 501b of the electrode structure 110 and/or the counter-electrode structure 112 in a unit cell member is adjacent the electrically insulating separator 130 of that unit cell. For example, in one embodiment, the porous electrically insulating material substantially fills regions of the upper and lower recesses 505a, 505b that are inwardly disposed with respect to the upper and lower end surface 500a, 500bs of the electrode structures 110 in members of the unit cell population, and that are abutting a first side 131a of the electrically insulating separator 130 facing the counter-electrode structure 110. According to certain embodiments, the porous electrically insulating material fills at least a portion of the upper and/or lower recesses 505a,505b that are recessed inwardly from the upper and lower end surfaces 502a, 502b of the electrically insulating separator 130, to provide structural support to the electrically insulating separator 130. For example, the porous electrically insulating material can, in certain embodiments, provide a rigid material abutting the upper and lower vertical ends 133a, 133b of the electrically insulating separator 130, to maintain an upright position of the vertical ends with respect to the upper and lower end surfaces of the counter-electrode structures 112. Maintaining the position of the vertical ends 133a, 133b of the electrically insulating separator 130 can, in certain embodiments, reduce the likelihood of electrical shorting between the electrode and counter-electrode structures, and other undesirable effects. The porous electrically insulating material can also, in certain embodiments, reduce undesirable electrical edge effects at portions of the upper and lower end surfaces of the counter-electrode structures.

Referring to FIGS. 3A-3B, according to certain embodiments, a method of transferring carrier ions from the auxiliary electrode 686 to the members of the unit cell population 504, through the porous electrically insulating material 508, is provided. As discussed above, the carrier ions may be transferred to provide carrier ions to the electrode structures 110 of the unit cell members to compensate for a loss of carrier ions resulting from formation of a solid electrolyte interphase (SEI) layer that can form during an initial formation process, or a subsequent charging cycle of a secondary battery 102 having the electrode assembly 106. In certain embodiments, a portion of the carrier ions introduced into the unit cell from the counter-electrode structure is irreversibly bound in this SEI layer and thus removed from cyclic operation, i.e., from the capacity available to the user. As a result, during the initial discharge, less carrier ion is returned to the counter-electrode structure from the electrode structure than was initially provided by the cathode during the initial charging operation, leading to irreversible capacity loss. During each subsequent charge and discharge cycle of the secondary battery, the capacity losses resulting from mechanical and/or electrical degradation to the electrode structure and/or the counter-electrode structure tend to be much less per cycle, but even the relatively small carrier ion losses per cycle contribute significantly to reductions in energy density and cycle life as the battery ages. In addition, chemical and electrochemical degradation may also occur on the electrode and counter-electrode structures and cause capacity losses. Accordingly, embodiments of the disclosure herein provide for methods of activating the electrode assembly and/or secondary battery, such as via an initial formation process that provides added carrier ions from the auxiliary electrode to the unit cell members, and/or during replenishment processes performed to replenish a content of carrier ions lost during subsequent charge and/or discharge cycles of the secondary battery having the electrode assembly. According to certain embodiments, the carrier ions are transferred to compensate for a loss of carrier ions during an initial or subsequent charging cycle of the electrode assembly.

According to one embodiment, the auxiliary electrode 686 comprises a source of carrier ions such as any of lithium, sodium, potassium, calcium, magnesium and aluminum ions. In the embodiment as shown in FIG. 3A, the auxiliary electrode 686 is positioned over the apertures 176 in the first and/or second secondary growth constraints 158, 160, which are located over the vertical end surfaces of the electrode structures, counter-electrode structures and electrically insulating separators of the unit cell members. In one version, one or more auxiliary electrodes 686 are positioned over apertures 176 located in both the first and second secondary growth constraints 158, 160, and/or alternatively the auxiliary electrode 686 can be positioned over apertures 176 of just one of the first and second secondary growth constraints. For example, in one embodiment, a first auxiliary electrode 686a is positioned over apertures 176 in the first secondary growth constraint 158, and a second auxiliary electrode 686b is positioned over apertures 176 in the second secondary growth constraint 160. In one embodiment, the auxiliary electrode(s) 686 are provided in direct physical contact with upper and lower outer surfaces 401a, 401b of the first and second secondary growth constraints, 401a, 401b. In one embodiment, the auxiliary electrode(s) 686 are provided directly over the apertures 176, and in direct physical contact with the porous electrically insulating material provided in the apertures 176. The auxiliary electrode 686 may be selectively electrically connected or coupled to one or more of the electrode structures 110 and/or the counter-electrode structures 112 of the unit cell members, e.g., by a switch and/or a control unit (not shown). According to certain embodiments, the auxiliary electrode is electrolytically or otherwise coupled to the counter-electrode structure and/or the electrode structure (e.g. through the separator) of members of the unit cell population, to provide a flow of carrier ions from the auxiliary electrode to the electrode and/or counter-electrode structures. By electrolytically coupled, it is meant that the carrier ions can be transferred through electrolyte, such as from the auxiliary electrode to the electrode and/or counter-electrode structures 110, 112, as well as between electrode and counter-electrode structures 110, 112. The auxiliary electrode 686 is also electrically coupled directly or indirectly to the electrode and/or counter-electrode structures 110, 112, such by a series of wires or other electrical connection.

In one embodiment, the carrier ions are transferred to achieve and/or restore a predetermined counter-electrode structure end of discharge voltage V_{ces eod}, and a predetermined electrode structure end of discharge voltage V_{es,eod}, where for a unit cell of the population, the discharge voltage for the unit cell V_{cell,eod}=V_{es,eod}−V_{ces,eod}. For example, in one embodiment, the electrode structure end of discharge voltage V_{es,eod} is less than 0.9 V (vs. Li) and greater than 0.4 V (vs. Li) when the unit cell members and/or secondary battery containing the unit cell members reaches the cell end of discharge voltage V_{cell,eod} during a discharge cycle of the secondary battery (after the initial charge and discharge cycle when SEI is formed). Thus, for example, in one such embodiment the electrode end of discharge voltage V_{es,eod} may be in the range of about 0.5 V (vs. Li) to about 0.8 V (vs. Li) when the secondary battery reaches the cell end of discharge voltage V_{cell,eod} during a discharge cycle of the secondary battery (i.e., when the cell is under a discharge load). By way of further example, in one such embodiment the electrode structure end of discharge voltage V_{es,eod} may be in the range of about 0.6 V (vs. Li) to about 0.8 V (vs. Li) when the secondary battery reaches the cell end of discharge voltage V_{cell,eod} during a discharge cycle of the secondary battery (i.e., when the cell is under a discharge load). In one such embodiment the electrode structure end of discharge voltage V_{es,eod} may be in the range of about 0.6 V (vs. Li) to about 0.7 V (vs. Li) when the secondary battery reaches the cell end of discharge voltage V_{cell,eod} during a discharge cycle of the secondary battery (i.e., when the cell is under a discharge load).

According to yet another embodiment, the predetermined counter-electrode structure V_{ces,eod} value corresponds to a voltage at which the state of charge of the counter-electrode structure is at least 95% of its reversible coulombic capacity and V_{ces,eod} is at least 0.4 V (vs Li) but less than 0.9 V (vs Li). For example, in one such embodiment, when V_{cell,eod} is reached, the counter-electrode structure has a V_{ces,eod} value that corresponds to a voltage at which the state of charge of the counter-electrode structure is at least 96% of its reversible coulombic capacity and V_{es,eod} is at least 0.4 V (vs Li) but less than 0.9 V (vs Li). By way of further example, in one such embodiment when V_{cell,eod} is reached, the counter-electrode structure has a V_{ces,eod} value that corresponds to a voltage at which the state of charge of the counter-electrode structure is at least 97% of its reversible coulombic capacity and V_{es,eod} is at least 0.4 V (vs Li) but less than 0.9 V (vs Li). By way of further example, in one such embodiment when V_{cell,eod} is reached, the counter-electrode structure has a V_{ces,eod} value that corresponds to a voltage at which the state of charge of the counter-electrode structure is at least 98% of its reversible coulombic capacity and V_{es,eod} is at least 0.4 V (vs Li) but less than 0.9 V (vs Li). By way of further example, in one such embodiment when V_{cell,eod} is reached, the counter-electrode structure has a V_{ces,eod} value that corresponds to a voltage at which the state of charge of the counter-electrode structure is at least 99% of its reversible coulombic capacity and V_{es,eod} is at least 0.4 V (vs Li) but less than 0.9 V (vs Li).

According to one embodiment, the method comprises (i) transferring carrier ions from counter-electrode structures to electrode structures in the unit cell population during an initial or subsequent charging cycle to at least partially charge the electrode assembly, and (ii) transferring carrier ions from the auxiliary electrode, to counter-electrode structures and/or electrode structures, through the porous electrically insulating material, the auxiliary electrode being electrolytically coupled to the counter-electrode structure and/or electrode structure of members of the unit cell population, through the separator, to provide the electrode assembly with the predetermined counter-electrode structure end of discharge voltage V_{cos,eod}, and the predetermined electrode structure end of discharge voltage V_{es,eod}. According to one embodiment, the method further comprises (iii) transferring, after (ii), carrier ions from the counter-electrode structure to the electrode structure of members of the unit cell population to charge the electrode assembly. For example, the carrier ions transferred from the auxiliary electrode during (ii) to the counter-electrode structures, can be subsequently transferred from the counter-electrode structures to the electrode structures in (iii). According to yet another embodiment, (ii) is performed simultaneously with (i). According to certain embodiments, in (ii), a bias voltage is applied between the auxiliary electrode and the electrode structure and/or counter-electrode structure of members of the unit cell population to provide a flow of carrier ions through the porous electrically insulating material members to the electrode and/or counter-electrode structures. Similarly, in (i) and (iii) a bias voltage can be applied between the electrode structure and counter-electrode structure of members of the unit cell population, to provide a flow of carrier ions from the counter-electrode structure to the electrode structure of the members.

According to one embodiment, the method of transferring carrier ions to the members of the unit cell population comprises aligning one or more auxiliary electrodes over apertures 176 in the first and/or second secondary growth constraint, and applying a pressure in a range of greater than 0 psi to no more than 20 psi, to press the auxiliary electrode(s) and the first or second secondary growth constraint against one another. For example, the method can comprise applying a pressure in a range of greater than 5 psi to no more than 20 psi to press the auxiliary electrode and the first or second secondary growth constraint against one another. According to certain embodiments, the pressure is applied to contact the auxiliary electrode with porous electrically insulating material disposed in the apertures, so as to provide for efficient transfer of the carrier ions into and through the porous electrically insulating material in the apertures 176. In one embodiment, the presence of the porous electrically insulating material 508 in the apertures 176, and/or in regions of the electrode assembly enclosed within the constraint system and covering the upper and/or lower end surfaces of the electrodes and/or counter-electrodes 110, 112, may provide for enhanced uniformity in transfer of the carrier ions from the auxiliary electrode to the unit cell members. Without being limited to any particular theory, it is believed that the presence of the electrically insulating material 508 in the apertures 176 may deter the formation of gas pockets that may otherwise form in such apertures as a by-product of the chemical processes that occur during charging processes. The current inventors have discovered that gases formed during the charging processes can become trapped at the interface between the apertures and auxiliary electrode, thereby impeding the transfer of carrier ions from those regions of the auxiliary electrode adjacent to where gas has developed. In certain embodiments, the porous electrically insulating material deters the formation of such pockets of gas, while maintaining the efficient transfer of carrier ions. Furthermore, in certain embodiments the formation of gas is further deterred by applying pressure to press the auxiliary electrode and first and/or second secondary growth constraint against one another, so as to provide good contact between the auxiliary electrode and porous electrically insulating material in the apertures of the constraint, and thereby reduce a volume of space available where a gas could form between the auxiliary electrode and the first and/or second secondary growth constraint.

According to one embodiment, the electrode structures 110 of the members of the unit cell population comprise electrode active material layers 132 and electrode current collector layers 136, and the counter-electrode structures 112 of members of the unit cell population comprise counter-electrode active material layers 138 and counter-electrode current collector layers 140, and the porous electrically insulating material 508 covers upper and lower end surfaces 507a, 507b the counter-electrode active material layers of the members of the unit cell population. In the embodiment as shown in FIGS. 3A and 4, the porous electrically insulating material extends in the stacking direction across, and covers, the upper and lower end surfaces 501a, 501b of the counter-electrode structures 112, including across one or more of the upper and lower end surfaces 507a, 507b of counter-electrode active material layers 138 in adjacent unit cells 504a, 504b, and in certain embodiments across the upper and lower end surfaces 509a, 509b of the counter-electrode current collector 140 shared by the adjacent unit cells 504. The porous electrically insulating material extending across portions of adjacent unit cells in this embodiment can abut and provide structural support for the vertical ends 133a, 133b of electrically insulating separators 130 in adjacent unit cells. In yet further embodiments, the porous electrically insulating material 508 can be provided on upper and lower end surfaces of the electrode structures 110, such as on upper and lower end surfaces 511a, 511b of electrode active material layers 132 in adjacent unit cells 504a, 504b, and across the upper and lower end surfaces 510a, 510b of the electrode current collector 136 shared by the adjacent unit cells 504.

According to yet further embodiments, the porous electrically insulating material 508 is provided on those portions of the upper and lower end surfaces of the electrode and counter-electrode structures where a path is provided for flow of carrier ions from the auxiliary electrode to the members of the unit cell population. For example, in embodiments where a flow of carrier ions is provided from the auxiliary electrode to the counter-electrode structures 112, the porous electrically insulating material 508 is disposed on upper and lower end surfaces of the counter-electrode structures, to provide a path for carrier ions to the counter-electrode structures. As another example, in embodiments where a flow of carrier ions is provided from the auxiliary electrode to the electrode structures 110, the porous electrically insulating material 508 is disposed on upper and lower end surfaces of the electrode structures, to provide a path for carrier ions to the electrode structures.

According to certain embodiments, a porosity of the electrically insulating material 508 can be selected to provide a predetermined conductivity of carrier ions through the material. In certain embodiments, the porous electrically insulating material comprises a porosity of at least 25%, at least 30%, at least 35%, at least 40%, at least 45%, at least 50%, and/or at least 55%. Furthermore, in certain embodiments, the porous electrically insulating material comprises a porosity of no more than 55%, no more than 50%, no more than 45%, no more than 40%, and/or no more than 35%. According to yet another embodiment, the porous electrically insulating material 508 comprises a ratio of porosity with respect to a porosity of the electrically insulating separators 130 between electrode and counter-electrode structures within members of the unit cell population that is in a range of from 1:0.75 to 1:1.5.

In one embodiment, the porous electrically insulating material 508 comprises particulate material dispersed in a binder material. For example, the particulate material can comprise a stable metal oxide and/or ceramic, such as one or more of alumina, boron nitride, titania, silica, zirconia, magnesium oxide and calcium oxide. In another embodiment, the particulate material comprises particles having a d50 particle size (median particle size) of at least 0.35 microns, at least 0.45 microns, at least 0.5 microns, and/or at least 0.75 microns. In yet another embodiment, the particulate material comprises particles having a d50 particle size (median particle size) of no more than 40 microns, no more than 35 microns, no more than 25 microns and/or no more than 20 microns. In one embodiment, at least 80%, at least 85%, at least 90%, and/or at least 95% by weight of the particles have a particle size of at least 0.35 microns, at least 0.45 microns, at least 0.5 microns, and/or at least 0.75 microns, and no more than 40 microns, no more than 35 microns, no more than 25 microns and/or no more than 20 microns. Furthermore, in one embodiment, the particulate material comprises at least 70 wt %, at least 75 wt %, at least 80 wt %, and/or at least 85 wt %, of the porous electrically insulating material. In a further embodiment, the particulate material comprises no more than 99.5 wt %, no more than 97 wt %, no more than 95 wt %, and/or no more than 90 wt % of the porous electrically insulating material. In one embodiment, the binder material comprises a polymeric material selected from any of the group consisting of polyvinylidene fluoride (PVDF), polyethylene, polypropylene, ethylene acrylic acid (EAA), ethylene methacrylic acid (EMAA), and copolymers thereof.

Referring to FIGS. 1A-1D, according to one embodiment, the electrode assembly 106 has mutually perpendicular transverse, longitudinal and vertical axes corresponding to the x, y and z axes, respectively, of an imaginary three-dimensional Cartesian coordinate system, a first longitudinal end surface 116 and a second longitudinal end surface 118 separated from each other in the longitudinal direction, and a lateral surface 142 surrounding an electrode assembly longitudinal axis A_{EA} and connecting the first and second longitudinal end surfaces 116, 118. The lateral surface 142 comprises first and second regions on opposite sides of the longitudinal axis and separated in a first direction that is orthogonal to the longitudinal axis. For example, the lateral surface 142 can comprise opposing surface regions 144, 146 in the X direction (i.e., the side surfaces of the rectangular prism) and opposing surface regions 148, 150 in the Z direction. In yet another embodiment, the lateral surface can comprise a cylindrical shape. The electrode assembly 106 can further comprise a maximum width W_{EA} measured in the longitudinal direction, a maximum length L_{EA} bounded by the lateral surface and measured in the transverse direction, and a maximum height H_{EA} bounded by the lateral surface and measured in the vertical direction. In one embodiment, a ratio of the maximum length L_{EA} to the maximum height H_{EA} may be at least 2:1. By way of further example, in one embodiment a ratio of the maximum length L_{EA} to the maximum height H_{EA} may be at least 5:1. By way of further example, in one embodiment, the ratio of the maximum length L_{EA} to the maximum height H_{EA} may be at least 10:1. By way of further example, in one embodiment, the ratio of the maximum length L_{EA} to the maximum height H_{EA} may be at least 15:1. By way of further example, in one embodiment, the ratio of the maximum length L_{EA} to the maximum height H_{EA} may be at least 20:1. The ratios of the different dimensions may allow for optimal configurations within an energy storage device to maximize the amount of active materials, thereby increasing energy density.

In some embodiments, the maximum width W_{EA} may be selected to provide a width of the electrode assembly 106 that is greater than the maximum height H_{EA}. For example, in one embodiment, a ratio of the maximum width W_{EA} to the maximum height H_{EA} may be at least 2:1. By way of further example, in one embodiment, the ratio of the maximum width W_{EA} to the maximum height H_{EA} may be at least 5:1. By way of further example, in one embodiment, the ratio of the maximum width W_{EA} to the maximum height H_{EA} may be at least 10:1. By way of further example, in one embodiment, the ratio of the maximum width W_{EA} to the maximum height H_{EA} may be at least 15:1. By way of further example, in one embodiment, the ratio of the maximum width W_{EA} to the maximum height H_{EA} may be at least 20:1.

According to one embodiment, a ratio of the maximum width W_{EA} to the maximum length L_{EA} may be selected to be within a predetermined range that provides for an optimal configuration. For example, in one embodiment, a ratio of the maximum width W_{EA} to the maximum length L_{EA} may be in the range of from 1:5 to 5:1. By way of further example, in one embodiment a ratio of the maximum width W_{EA} to the maximum length L_{EA} may be in the range of from 1:3 to 3:1. By way of yet a further example, in one embodiment a ratio of the maximum width W_{EA} to the maximum length L_{EA} may be in the range of from 1:2 to 2:1.

According to embodiments of the present disclosure, each electrode structure 110 of members of the unit cell population comprise a length L_{E} as measured in the transverse direction between first and second opposing transverse end surfaces 601a, 601b of the electrode structure 110, and a height H_{E} as measured in the vertical direction between upper and lower opposing vertical end surfaces 500a, 500b of the electrode structure, and a width W_{E} as measured in the longitudinal direction between first and second opposing surfaces 603a, 603b of the electrode structure, and each counter-electrode structure 112 of members of the unit cell population comprises a length L_{CE} as measured in the transverse direction between first and second opposing transverse end surfaces 602a, 602b of the counter-electrode structure, a height H_{CE} as measured in the vertical direction between upper and lower second opposing vertical end surfaces 501a, 501b of the counter-electrode structure, and a width W_{CE} as measured in the longitudinal direction between first and second opposing surfaces 604a, 604b of the counter-electrode structure.

According to one embodiment, a ratio of L_{E} to each of W_{E} and H_{E} is at least 5:1, respectively, and a ratio of H_{E} to W_{E} is in the range of about 2:1 to about 100:1, for electrode structures 110 of members of the unit cell population, and the ratio of L_{CE} to each of W_{CE} and H_{CE} is at least 5:1, respectively, and a ratio of H_{CE} to W_{CE} is in the range of about 2:1 to about 100:1, for counter-electrode structures 112 of members of the unit cell population. By way of further example, in one embodiment the ratio of L_{E} to each of W_{E} and H_{E} is at least 10:1, and the ratio of L_{CE} to each of W_{CE} and H_{CE} is at least 10:1. By way of further example, in one embodiment, the ratio of L_{E} to each of W_{E} and H_{E} is at least 15:1, and the ratio of L_{CE} to each of W_{CE} and H_{CE} is at least 15:1. By way of further example, in one embodiment, the ratio of L_{E} to each of W_{E} and H_{E} is at least 20:1, and the ratio of L_{CE} to each of W_{CE} and H_{CE} is at least 20:1.

In one embodiment, the ratio of the height (H_{E}) to the width (W_{E}) of the electrode structures 110 is at least 0.4:1, respectively. For example, in one embodiment, the ratio of H_{E} to W_{E} will be at least 2:1, respectively, for each electrode structure 110 of members of the unit cell population. By way of further example, in one embodiment the ratio of H_{E} to W_{E} will be at least 10:1, respectively. By way of further example, in one embodiment the ratio of H_{E} to W_{E} will be at least 20:1, respectively. Typically, however, the ratio of H_{E} to W_{E} will generally be less than 1,000:1, respectively. For example, in one embodiment the ratio of H_{E} to W_{E} will be less than 500:1, respectively. By way of further example, in one embodiment the ratio of H_{E} to W_{E} will be less than 100:1, respectively. By way of further example, in one embodiment the ratio of H_{E} to W_{E} will be less than 10:1, respectively. By way of further example, in one embodiment the ratio of H_{E} to W_{E} will be in the range of about 2:1 to about 100:1, respectively, for each electrode structure of members of the unit cell population.

In one embodiment, the ratio of the height (H_{CE}) to the width (W_{CE}) of the counter-electrode structures 112 is at least 0.4:1, respectively. For example, in one embodiment, the ratio of H_{CE} to W_{CE} will be at least 2:1, respectively, for each counter-electrode structure 112 of members of the unit cell population. Byway of further example, in one embodiment the ratio of H_{CE} to W_{CE} will be at least 10:1, respectively. By way of further example, in one embodiment the ratio of H_{CE} to W_{CE} will be at least 20:1, respectively. Typically, however, the ratio of H_{CE} to W_{CE} will generally be less than 1,000:1, respectively. For example, in one embodiment the ratio of H_{CE} to W_{CE} will be less than 500:1, respectively. By way of further example, in one embodiment the ratio of H_{CE} to W_{CE} will be less than 100:1, respectively. By way of further example, in one embodiment the ratio of H_{CE} to W_{CE} will be less than 10:1, respectively. By way of further example, in one embodiment the ratio of H_{CE} to W_{CE} will be in the range of about 2:1 to about 100:1, respectively, for each counter-electrode structure of members of the unit cell population.

In one embodiment, the unit cell populations can comprise alternating sequence of electrode and counter-electrode structures 110 and 112, and, may include any number of members, depending on the energy storage device 100 and the intended use thereof. By way of further example, in one embodiment, and stated more generally, the population of electrode structures 110 and the population of counter-electrode structures 112 each have N members, each of N−1 electrode structure members 110 is between two counter-electrode structure members 112, each of N−1 counter-electrode structure members 112 is between two electrode structure members 110, and N is at least 2. By way of further example, in one embodiment, N is at least 4. By way of further example, in one embodiment, N is at least 5. By way of further example, in one embodiment, N is at least 10. By way of further example, in one embodiment, N is at least 25. By way of further example, in one embodiment, N is at least 50. By way of further example, in one embodiment, N is at least 100 or more.

According to a further embodiment of the present disclosure, a method of manufacture of the electrode assembly and/or secondary battery is provided. According to one embodiment, the method of manufacture comprises providing the population of unit cells stacked in series in a stacking direction, wherein (i) each unit cell comprises the electrode structure, the counter-electrode structure, and the electrically insulating separator between the electrode and counter-electrode structures, (ii) the electrode structures, counter-electrode structures and electrically insulating separators within each unit cell have opposing upper and lower end surfaces separated in the vertical direction, and (iii) the vertical direction is orthogonal to the stacking direction. The manufacturing method further comprises enclosing the population of unit cells within a volume defined by a constraint system comprising (i) first and second primary growth constraints separated in the longitudinal direction, and (ii) first and second secondary growth constraints separated in the vertical direction and connecting the first and second primary growth constraints, wherein (iii) the first secondary growth constraint is further connected to the upper end surfaces of the electrode or counter-electrode structures of a subset of the unit cell population, (iv) the second secondary growth constraint is further connected to the lower end surfaces of the electrode or counter-electrode structures of a subset of the unit cell population, and (v) the first or second secondary growth constraint comprises a plurality of apertures through a vertical thickness thereof. According to embodiments of the manufacturing method, the method further comprises providing porous electrically insulating material within the plurality of apertures, the porous electrically insulating material providing a path for carrier ions through the apertures, the electrically insulating material having a porosity in the range of from 20% to 60%. According to one embodiment, the porous electrically insulating material is provided by filling the plurality of apertures with a slurry or paste comprising particulate material binder material in a solvent, and evaporating the solvent to leave particulate material dispersed in the binder material in the plurality of apertures. For example, in the embodiment as shown in FIG. 6, the slurry and/or paste 900 is applied to the one or more of the upper and lower inner surfaces and/or upper and lower outer surfaces of the first and/or second secondary growth constraints 158, 160 to at least partly fill the apertures 176.

In one embodiment, the binder material is soluble in the solvent, and the solvent is evaporated by heating and/or drying of the solvent by gas flow. For example, the solvent can comprise any of N-methyl-2-pyrrolidone (NMP), heptane, octane, toluene, xylene, or mixed hydrocarbon solvents. Furthermore, according to certain embodiments, the slurry and/or paste comprises at least 50 wt %, at least 55 wt %, at last 60 wt %, at least 65 wt %, at least 70 wt %, at least 75 wt %, and/or at least 80 wt % of particulate material, and no more than 90%, no more than 85 wt %, no more than 80 wt %, and/or no more than 75 wt % of particulate material.

According to one embodiment, the method of manufacture further comprises connecting the first and second secondary growth constraints separated in the vertical direction to the electrode current collectors of the subset of members of the electrode structures, the first and second secondary growth constraints comprising the apertures formed through respective vertical thicknesses thereof, wherein the secondary growth constraint system at least partially restrains growth of the electrode assembly in the vertical direction upon cycling of the electrode assembly. For example, the growth constraints can be connected to the exposed upper and lower ends of the electrode current collectors, as shown in FIG. 5A.

In yet another embodiment, the method of manufacture of the electrode assembly and/or secondary battery comprises (1) providing the auxiliary electrode comprising a source of carrier ions external to the volume enclosed by the constraint system, and (2) applying a bias voltage between the auxiliary electrode and the members of the electrode population or members of the counter-electrode population to provide a flow of carrier ions through the apertures in the first and second secondary growth constraints and through the porous electrically insulating material in the apertures to the electrode population and/or counter-electrode structures of members of the unit cell population. For example, the method of manufacture can comprise processes for the formation of a secondary battery, including initial charging processes to charge the secondary battery and/or charge up the electrode structures, and processes to replenish carrier lost in an initial charging processes. According to certain embodiments, the method of manufacture of the electrode assembly and/or secondary battery can comprise any of the methods of providing carrier ions to the members of the unit cell population described herein. According to further embodiments, the method for transferring carrier ions from the auxiliary electrode comprising the source of carrier ions to the electrode assembly can be performed during an initial or subsequent charging cycle of the secondary battery and/or electrode assembly.

In one embodiment, a method for preparing an electrode assembly 106 comprising a constraint system 108 is provided, where the electrode assembly 106 may be used as a part of a secondary battery that is configured to cycle between a charged and a discharged state. The method can generally comprise forming a sheet structure, cutting the sheet structure into pieces (and/or pieces), stacking the pieces, and applying the constraint system. By strip, it is understood that a piece other than one being in the shape of a strip could be used. The pieces comprise an electrode active material layer, an electrode current collector, a counter-electrode active material layer, a counter-electrode current collector, and a separator, and may be stacked so as to provide an alternating arrangement of electrode active material and/or counter-electrode active material. The sheets can comprise, for example, at least one of a unit cell 504 and/or a component of a unit cell 504. For example, the sheets can comprise a population of unit cells, which can be cut to a predetermined size (such as a size suitable for a 3D battery), and then the sheets of unit cells can be stacked to form the electrode assembly 106. In another example, the sheets can comprise one or more components of a unit cell, such as for example at least one of an electrode current collector 136, an electrode active material layer 132, a separator 130, a counter-electrode active material layer 138, and a counter-electrode current collector 140. The sheets of components can be cut to predetermined sizes to form the pieces (such as sizes suitable for a 3D battery), and then stacked to form an alternating arrangement of the electrode and counter-electrode active material layer components.

In yet another embodiment, the constraint system 108 that are applied may correspond to any of those described herein, such as for example a constraint system comprising a primary growth constraint system comprising first and second primary growth constraints and at least one primary connecting member, the first and second primary growth constraints separated from each other in the longitudinal direction, and the at least one primary connecting member connecting the first and second primary growth constraints. Furthermore, the constraint system can comprise a secondary growth constraint system comprising first and second secondary growth constraints separated in a direction orthogonal to the longitudinal direction (such as the vertical or transverse direction) and connected by at least one secondary connecting member, wherein the secondary growth constraint system at least partially restrains growth of the electrode assembly in the vertical direction upon cycling of the secondary battery. At least one of the primary connecting member, or first and/or second primary growth constraints of the primary growth constraint system, and the secondary connecting member, or first and/or second secondary growth constraints of the secondary growth constraint system, can be one or more of the assembly components that make up the pieces, such as for example at least one of the electrode active material layer, electrode current collector, counter-electrode active material layer, counter-electrode current collector, and separator. For example, in one embodiment, the primary connecting member of the primary growth constraint system can be one or more of the assembly components that make up the pieces, such as for example at least one of the electrode active material layer, electrode current collector, counter-electrode active material layer, counter-electrode current collector, and separator. That is, the application of the constraints may involve applying the first and second primary growth constraints to a primary member connecting member that is one of the structures in the stack of pieces.

Referring now to FIG. 2, illustrated is an exploded view of one embodiment of a secondary battery 102 having a constraint system 108 of the present disclosure. The secondary battery 102 includes battery enclosure 104 and an electrode assembly within the battery enclosure 104, the electrode assembly 106 having a first longitudinal end surface 116, an opposing second longitudinal end surface 118 (i.e., separated from first longitudinal end surface 116 along the Y axis the Cartesian coordinate system shown), as described above. Alternatively, the secondary battery 102 may comprise a plurality of electrode assemblies 106 with a constraint system 108 provided within the enclosure. The electrode assembly 106 includes a population of electrode structures 110 and a population of counter-electrode structures 112, stacked relative to each other within each of the electrode assemblies 106 in a stacking direction D, stated differently, the populations of electrode 110 and counter-electrode 112 structures are arranged in an alternating series of electrode structures 110 and counter-electrode structures 112 with the series progressing in the stacking direction D between first and second longitudinal end surfaces 116, 118, respectively.

According to the embodiment shown in FIG. 2, tabs 190, 192 project out of the battery enclosure 104 and provide an electrical connection between the electrode assembly 106 and an energy supply or consumer (not shown). More specifically, in this embodiment tab 190 is electrically connected to tab extension 191 (e.g., using an electrically conductive glue), and tab extension 191 is electrically connected to the electrode structures 110 comprised by the electrode assembly 106. Similarly, tab 192 is electrically connected to tab extension 193 (e.g., using an electrically conductive glue), and tab extension 193 is electrically connected to the counter-electrode structures 112 comprised by of the electrode assembly 106. The tab extensions 191, 193 may also serve as bus bars that pool current from each of the respective electrode and counter-electrode structures to which they are electrically connected.

The electrode assembly 106 in the embodiment illustrated in FIG. 2 has an associated primary growth constraint system 151 to restrain growth in the longitudinal direction (i.e., stacking direction D). Alternatively, in one embodiment, a plurality of electrode assemblies 106 may share at least a portion of the primary growth constraint system 151. In the embodiment as shown, each primary growth constraint system 151 includes first and second primary growth constraints 154, 156, respectively, that may overlie first and second longitudinal end surfaces 116, 118, respectively, as described above; and first and second opposing primary connecting members 162, 164, respectively, that may overlie the lateral surface 142, as described above. First and second opposing primary connecting members 162, 164, respectively, may pull first and second primary growth constraints 154, 156, respectively, towards each other, or alternatively stated, assist in restraining growth of the electrode assembly 106 in the longitudinal direction, and primary growth constraints 154, 156 may apply a compressive or restraint force to the opposing first and second longitudinal end surfaces 116, 118, respectively. As a result, expansion of the electrode assembly 106 in the longitudinal direction is inhibited during formation and/or cycling of the battery 102 between charged and discharged states. Additionally, primary growth constraint system 151 exerts a pressure on the electrode assembly 106 in the longitudinal direction (i.e., stacking direction D) that exceeds the pressure maintained on the electrode assembly 106 in either of the two directions that are mutually perpendicular to each other and are perpendicular to the longitudinal direction (e.g., as illustrated, the longitudinal direction corresponds to the direction of the Y axis, and the two directions that are mutually perpendicular to each other and to the longitudinal direction correspond to the directions of the X axis and the Z axis, respectively, of the illustrated Cartesian coordinate system).

Further, the electrode assembly 106 in the embodiment illustrated in FIG. 2 has an associated secondary growth constraint system 152 to restrain growth in the vertical direction (i.e., expansion of the electrode assembly 106, electrodes 110, and/or counter-electrodes 112 in the vertical direction (i.e., along the Z axis of the Cartesian coordinate system)). Alternatively, in one embodiment, a plurality of electrode assemblies 106 share at least a portion of the secondary growth constraint system 152. Each secondary growth constraint system 152 includes first and second secondary growth constraints 158, 160, respectively, that may overlie the lateral surface 142, and at least one secondary connecting member 166, each as described in more detail above. Secondary connecting members 166 may pull first and second secondary growth constraints 158, 160, respectively, towards each other, or alternatively stated, assist in restraining growth of the electrode assembly 106 in the vertical direction, and first and second secondary growth constraints 158, 160, respectively, may apply a compressive or restraint force to the lateral surfaces 142), each as described above in more detail. As a result, expansion of the electrode assembly 106 in the vertical direction is inhibited during formation and/or cycling of the battery 102 between charged and discharged states. Additionally, secondary growth constraint system 152 exerts a pressure on the electrode assembly 106 in the vertical direction (i.e., parallel to the Z axis of the Cartesian coordinate system) that exceeds the pressure maintained on the electrode assembly 106 in either of the two directions that are mutually perpendicular to each other and are perpendicular to the vertical direction (e.g., as illustrated, the vertical direction corresponds to the direction of the Z axis, and the two directions that are mutually perpendicular to each other and to the vertical direction correspond to the directions of the X axis and the Y axis, respectively, of the illustrated Cartesian coordinate system).

According to certain embodiments, to complete the assembly of the secondary battery 102, the battery enclosure 104 can be filled with a non-aqueous electrolyte (not shown) and lid 104a is folded over (along fold line, FL) and sealed to upper surface 104b. When fully assembled, the sealed secondary battery 102 occupies a volume bounded by its exterior surfaces (i.e., the displacement volume), the secondary battery enclosure 104 occupies a volume corresponding to the displacement volume of the battery (including lid 104a) less its interior volume (i.e., the prismatic volume bounded by interior surfaces 104c, 104d, 104e, 104f, 104g and lid 104a) and each of the primary and secondary growth constraint systems 151, 152 of the electrode assembly 106 occupies a volume corresponding to its respective displacement volume. In combination, therefore, the battery enclosure 104 and the primary and secondary growth constraint systems 151, 152 occupy no more than 75% of the volume bounded by the outer surface of the battery enclosure 104 (i.e., the displacement volume of the battery). For example, in one such embodiment, the primary and secondary growth constraint systems 151, 152 and battery enclosure 104, in combination, occupy no more than 60% of the volume bounded by the outer surface of the battery enclosure 104. By way of further example, in one such embodiment, the primary and secondary growth constraint systems 151, 152 and battery enclosure 104, in combination, occupy no more than 45% of the volume bounded by the outer surface of the battery enclosure 104. By way of further example, in one such embodiment, the primary and secondary growth constraint systems 151, 152 and battery enclosure 104, in combination, occupy no more than 30% of the volume bounded by the outer surface of the battery enclosure 104. By way of further example, in one such embodiment, the primary and secondary growth constraint systems 151, 152 and battery enclosure 104, in combination, occupy no more than 20% of the volume bounded by the outer surface of the battery enclosure.

In general, the primary growth constraint system 151 and/or secondary growth constraint system 152 will typically comprise a material that has an ultimate tensile strength of at least 10,000 psi (>70 MPa), that is compatible with the battery electrolyte, does not significantly corrode at the floating or anode potential for the battery 102, and does not significantly react or lose mechanical strength at 45° C., and even up to 70° C. For example, the primary growth constraint system 151 and/or secondary growth constraint system 152 may comprise any of a wide range of metals, alloys, ceramics, glass, plastics, or a combination thereof (i.e., a composite). In one exemplary embodiment, primary growth constraint system 151 and/or secondary growth constraint system 152 comprises a metal such as stainless steel (e.g., SS 316, 440C or 440C hard), aluminum (e.g., aluminum 7075-T6, hard H18), titanium (e.g., 6Al-4V), beryllium, beryllium copper (hard), copper (O₂ free, hard), nickel, in general, however, when the primary growth constraint system 151 and/or secondary growth constraint system 152 comprises metal it is generally preferred that it be incorporated in a manner that limits corrosion and limits creating an electrical short between the electrode structures 110 and counter-electrode structures 112. In another exemplary embodiment, the primary growth constraint system 151 and/or secondary growth constraint system 152 comprises a ceramic such as alumina (e.g., sintered or Coorstek AD96), zirconia (e.g., Coorstek YZTP), yttria-stabilized zirconia (e.g., ENrG E-Strate®). In another exemplary embodiment, the primary growth constraint system 151 comprises a glass such as Schott D263 tempered glass. In another exemplary embodiment, the primary growth constraint system 151 and/or secondary growth constraint system 152 comprises a plastic such as polyetheretherketone (PEEK) (e.g., Aptiv 1102), PEEK with carbon (e.g., Victrex 90HMF40 or Xycomp 1000-04), polyphenylene sulfide (PPS) with carbon (e.g., Tepex Dynalite 207), polyetheretherketone (PEEK) with 30% glass, (e.g., Victrex 90HMF40 or Xycomp 1000-04), polyimide (e.g., Kapton®). In another exemplary embodiment, the primary growth constraint system 151 and/or secondary growth constraint system 152 comprises a composite such as E Glass Std Fabric/Epoxy, 0 deg, E Glass UD/Epoxy, 0 deg, Kevlar Std Fabric/Epoxy, 0 deg, Kevlar UD/Epoxy, 0 deg, Carbon Std Fabric/Epoxy, 0 deg, Carbon UD/Epoxy, 0 deg, Toyobo Zylon® HM Fiber/Epoxy. In another exemplary embodiment, the primary growth constraint system 151 and/or secondary growth constraint system 152 comprises fibers such as Kevlar 49 Aramid Fiber, S Glass Fibers, Carbon Fibers, Vectran UM LCP Fibers, Dyneema, Zylon.

Members of the electrode structure 110 and counter-electrode structure 112 populations can include an electroactive material capable of absorbing and releasing a carrier ion such as lithium, sodium, potassium, calcium, magnesium or aluminum ions. In some embodiments, members of the electrode structure 110 population include an anodically active electroactive material (sometimes referred to as a negative electrode) and members of the counter-electrode structure 112 population include a cathodically active electroactive material (sometimes referred to as a positive electrode). In other embodiments, members of the electrode structure 110 population include a cathodically active electroactive material and members of the counter-electrode structure 112 population comprise an anodically active electroactive material. In each of the embodiments and examples recited in this paragraph, negative electrode active material may be, for example, a particulate agglomerate electrode, an electrode active material formed from a particulate material, such as by forming a slurry of the particulate material and casting into a layer shape, or a monolithic electrode.

According to one embodiment, an electrode active material used in an electrode structure 110 corresponding to an anode of the electrode assembly 106 comprises a material that expands upon insertion of carrier ions into the electrode active material during charge of the secondary battery 102 and/or electrode assembly 106. For example, the electrode active materials may comprise anodically active materials that accept carrier ions during charging of the secondary battery, such as by intercalating with or alloying with the carrier ions, in an amount that is sufficient to generate an increase in the volume of the electrode active material. For example, in one embodiment the electrode active material may comprise a material that has the capacity to accept more than one mole of carrier ion per mole of electrode active material, when the secondary battery 102 is charged from a discharged to a charged state. By way of further example, the electrode active material may comprise a material that has the capacity to accept 1.5 or more moles of carrier ion per mole of electrode active material, such as 2.0 or more moles of carrier ion per mole of electrode active material, and even 2.5 or more moles of carrier ion per mole of electrode active material, such as 3.5 moles or more of carrier ion per mole of electrode active material. The carrier ion accepted by the electrode active material may be at least one of lithium, potassium, sodium, calcium, and magnesium. Examples of electrode active materials that expand to provide such a volume change include one or more of silicon (e.g., SiO), aluminum, tin, zinc, silver, antimony, bismuth, gold, platinum, germanium, palladium, and alloys and compounds thereof. For example, in one embodiment, the electrode active material can comprise a silicon-containing material in particulate form, such as one or more of particulate silicon, particulate silicon oxide, and mixtures thereof. In another embodiment, the electrode active material consists of silicon or silicon oxide. In yet another embodiment, the electrode active material can comprise a material that exhibits a smaller or even negligible volume change. For example, in one embodiment the electrode active material can comprise a carbon-containing material, such as graphite. In yet another embodiment, the electrode structure comprises a layer of lithium metal, such as for example an electrode structure comprising an electrode current collector, on which a layer of lithium metal deposits during a charging process as a result of transfer of carrier ions from the counter-electrode structure to the electrode structure.

Furthermore, according to certain embodiments, exemplary anodically active electroactive materials include carbon materials such as graphite and soft or hard carbons, or any of a range of metals, semi-metals, alloys, oxides and compounds capable of forming an alloy with lithium. Specific examples of the metals or semi-metals capable of constituting the anode material include graphite, tin, lead, magnesium, aluminum, boron, gallium, silicon, Si/C composites, Si/graphite blends, SiOx, porous Si, intermetallic Si alloys, indium, zirconium, germanium, bismuth, cadmium, antimony, silver, zinc, arsenic, hafnium, yttrium, lithium, sodium, graphite, carbon, lithium titanate, palladium, and mixtures thereof. In one exemplary embodiment, the anodically active material comprises aluminum, tin, or silicon, or an oxide thereof, a nitride thereof, a fluoride thereof, or other alloy thereof. In another exemplary embodiment, the anodically active material comprises silicon, silicon oxide, or an alloy thereof.

In yet a further embodiment, anodically active material can comprise lithium metals, lithium alloys, carbon, petroleum cokes, activated carbon, graphite, silicon compounds, tin compounds, and alloys thereof. In one embodiment, the anodically active material comprises carbon such as non-graphitizable carbon, graphite-based carbon, etc.; a metal complex oxide such as LiₓFe₂O₃ (0≤x≤1), LiₓWO₂ (0≤x≤1), SnₓMe₁₋ₓMe′_{y}O_{z} (Me: Mn, Fe, Pb, Ge; Me′: Al, B, P, Si, elements found in Group 1, Group 2 and Group 3 in a periodic table, halogen; 0<x≤1; 1≤y≤3; 1≤z≤8), etc.; a lithium metal; a lithium alloy; a silicon-based alloy; a tin-based alloy; a metal oxide such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, Bi₂O₅, etc.; a conductive polymer such as polyacetylene, etc.; Li—Co—Ni-based material, etc. In one embodiment, the anodically active material can comprise carbon-based active material include crystalline graphite such as natural graphite, synthetic graphite and the like, and amorphous carbon such as soft carbon, hard carbon and the like. Other examples of carbon material suitable for anodically active material can comprise graphite, Kish graphite, pyrolytic carbon, mesophase pitch-based carbon fibers, meso-carbon microbeads, mesophase pitches, graphitized carbon fiber, and high-temperature sintered carbon such as petroleum or coal tar pitch derived cokes. In one embodiment, the negative electrode active material may comprise tin oxide, titanium nitrate and silicon. In another embodiment, the negative electrode can comprise lithium metal, such as a lithium metal film, or lithium alloy, such as an alloy of lithium and one or more types of metals selected from the group consisting of Na, K, Rb, Cs, Fr, Be, Mg, Ca, Sr, Ba, Ra, Al and Sn. In yet another embodiment, the anodically active material can comprise a metal compound capable of alloying and/or intercalating with lithium, such as Si, Al, C, Pt, Sn, Pb, Ir, Ni, Cu, Ti, Na, K, Rb, Cs, Fr, Be, Ca, Sr, Sb, Ba, Ra, Ge, Zn, Bi, In, Mg, Ga, Cd, a Si alloy, a Sn alloy, an Al alloy or the like; a metal oxide capable of doping and dedoping lithium ions such as SiOᵥ (0<v<2), SnO₂, vanadium oxide or lithium vanadium oxide; and a composite including the metal compound and the carbon material such as a Si—C composite or a Sn—C composite. For example, in one embodiment, the material capable of alloying/intercalating with lithium may be a metal, such as lithium, indium, tin, aluminum, or silicon, or an alloy thereof; a transition metal oxide, such as Li₄/3Ti₅/3O₄ or SnO; and a carbonaceous material, such as artificial graphite, graphite carbon fiber, resin calcination carbon, thermal decomposition vapor growth carbon, corks, mesocarbon microbeads (“MCMB”), furfuryl alcohol resin calcination carbon, polyacene, pitch-based carbon fiber, vapor growth carbon fiber, or natural graphite. In yet another embodiment, the negative electrode active material can comprise a composition suitable for a carrier ion such as sodium or magnesium. For example, in one embodiment, the negative electrode active material can comprise a layered carbonaceous material; and a composition of the formula NaₓSn_{y-z}M_{z} disposed between layers of the layered carbonaceous material, wherein M is Ti, K, Ge, P, or a combination thereof, and 0<x≤15, 1≤y≤5, and 0≤z≤1.

In one embodiment, the negative electrode active material may further comprise a conductive material and/or conductive aid, such as carbon-based materials, carbon black, graphite, graphene, active carbon, carbon fiber, carbon black such as acetylene black, Ketjen black, channel black, furnace black, lamp black, thermal black or the like; a conductive fiber such as carbon fiber, metallic fiber or the like; a conductive tube such as carbon nanotubes or the like; metallic powder such as carbon fluoride powder, aluminum powder, nickel powder or the like; a conductive whisker such as zinc oxide, potassium titanate or the like; a conductive metal oxide such as titanium oxide or the like; or a conductive material such as a polyphenylene derivative or the like. In addition, metallic fibers such as metal mesh; metallic powders such as copper, silver, nickel and aluminum; or organic conductive materials such as polyphenylene derivatives may also be used. In yet another embodiment, a binder may be provided, such as for example one or more of polyethylene, polyethylene oxide, polypropylene, polytetrafluoroethylene (PTFE), polyvinylidene fluoride (PVDF), styrene-butadiene rubber, a tetrafluoroethylene-perfluoro alkylvinyl ether copolymer, a vinylidene fluoride-hexafluoropropylene copolymer, a vinylidene fluoride-chlorotrifluoroethylene copolymer, an ethylene-tetrafluoroethylene copolymer, a polychlorotrifluoroethylene, vinylidene fluoride-pentafluoro propylene copolymer, a propylene-tetrafluoroethylene copolymer, an ethylene-chlorotrifluoroethylene copolymer, a vinylidene fluoride-hexafluoropropylene-tetrafluoroethylene copolymer, a vinylidene fluoride-perfluoromethylvinyl ether-tetrafluoro ethylene copolymer, an ethylene-acrylic acid copolymer and the like may be used either alone or as a mixture.

Exemplary cathodically active materials include any of a wide range of cathode active materials. For example, for a lithium-ion battery, the cathodically active material may comprise a cathode material selected from transition metal oxides, transition metal sulfides, transition metal nitrides, lithium-transition metal oxides, lithium-transition metal sulfides, and lithium-transition metal nitrides may be selectively used. The transition metal elements of these transition metal oxides, transition metal sulfides, and transition metal nitrides can include metal elements having a d-shell or f-shell. Specific examples of such metal element are Sc, Y, lanthanoids, actinoids, Ti, Zr, Hf, V, Nb, Ta, Cr, Mo, W, Mn, Tc, Re, Fe, Ru, Os, Co, Rh, Ir, Ni, Pb, Pt, Cu, Ag, and Au. Additional cathode active materials include LiCoO₂, LiNi_{0.5}Mn_{1.5}O₄, Li(NiₓCo_{y}Al_{z})O₂, LiFePO₄, Li₂MnO₄, V₂O₅, molybdenum oxysulfides, phosphates, silicates, vanadates, sulfur, sulfur compounds, oxygen (air), Li(NiₓMn_{y}Co₂)O₂, and combinations thereof. Furthermore, compounds for the cathodically active material layers can comprise lithium-containing compounds further comprising metal oxides or metal phosphates such as compounds comprising lithium, cobalt and oxygen (e.g., LiCoO₂), compounds comprising lithium, manganese and oxygen (e.g., LiMn₂O₄) and compound comprising lithium iron and phosphate (e.g., LiFePO). In one embodiment, the cathodically active material comprises at least one of lithium manganese oxide, lithium cobalt oxide, lithium nickel oxide, lithium iron phosphate, or a complex oxide formed from a combination of aforesaid oxides. In another embodiment, the cathodically active material can comprise one or more of lithium cobalt oxide (LiCoO₂), lithium nickel oxide (LiNiO₂), etc. or a substituted compound with one or more transition metals, lithium manganese oxide such as Li₁₊ₓMn₂₋ₓO₄ (where, x is 0 to 0.33), LiMnO₃, LiMn₂O₃, LiMnO₂, etc.; lithium copper oxide (Li₂CuO₂); vanadium oxide such as LiV₃O₈, LiFe₃O₄, V₂O₅, Cu₂V₂O₇ etc.; Ni site-type lithium nickel oxide represented by the chemical formula of LiNi₁₋ₓMₓO₂ (where, M=Co, Mn, Al, Cu, Fe, Mg, B or Ga, and x=0.01 to 0.3); lithium manganese complex oxide represented by the chemical formula of LiMn₂₋ₓMₓO₂ (where, M=Co, Ni, Fe, Cr, Zn or Ta, and x=0.01 to 0.1) or Li₂Mn₃MO₈ (where, M=Fe, Co, Ni, Cu or Zn); LiMn₂O₄ in which a portion of Li is substituted with alkaline earth metal ions; a disulfide compound; Fe₂(MoO₄)₃, and the like. In one embodiment, the cathodically active material can comprise a lithium metal phosphate having an olivine crystal structure of Formula Li₁₊ₐFe₁₋ₓM′ₓ(PO_{4-b})X_{b} wherein M′ is at least one selected from Al, Mg, Ni, Co, Mn, Ti, Ga, Cu, V, Nb, Zr, Ce, In, Zn, and Y, X is at least one selected from F, S, and N, −0.55≤a≤+0.5, 0≤x≤0.5, and 0≤b≤0.1, such at least one of LiFePO₄, Li(Fe, Mn)PO₄, Li(Fe, Co)PO₄, Li(Fe, Ni)PO₄, or the like. In one embodiment, the cathodically active material comprises at least one of LiCoO₂, LiNiO₂, LiMnO₂, LiMn₂O₄, LiNi_{1-y}Co_{y}O₂₁ LiCo_{1-y}Mn_{y}O₂, LiNi_{1-y}Mn_{y}O₂ (0≤y≤1), Li(NiₐCo_{b}Mn_{c})O₄ (0<a<2, 0<b<2, 0<c<2, and a+b+c=2), LiMn_{2-z}Ni_{z}O₄, LiMn_{2-z}Co_{z}O₄ (0<z<2), LiCoPO₄ and LiFePO₄, or a mixture of two or more thereof.

In yet another embodiment, a cathodically active material can comprise elemental sulfur (S8), sulfur series compounds or mixtures thereof. The sulfur series compound may specifically be Li₂Sₙ (n≥1), an organosulfur compound, a carbon-sulfur polymer ((C₂Sₓ)ₙ: x=2.5 to 50, n≥2) or the like. In yet another embodiment, the cathodically active material can comprise an oxide of lithium and zirconium.

In yet another embodiment, the cathodically active material can comprise at least one composite oxide of lithium and metal, such as cobalt, manganese, nickel, or a combination thereof, may be used, and examples thereof are LiₐA_{1-b}M_{b}D₂ (wherein, 0.90≤a≤1, and 0≤b≤0.5); LiₐE_{1-b}M_{b}O_{2-c}D_{c} (wherein, 0.90≤a≤1, 0≤b≤0.5, and 0≤c≤0.05); LiE_{2-b}M_{b}O_{4-c}D_{c} (wherein, 0≤b≤0.5, and 0≤c≤0.05); LiₐNi_{1-b-c}Co_{b}M_{c}Dₐ (wherein, 0.90≤a≤1, 0≤b≤0.5, 0≤c≤0.05, and 0<a≤2); LiₐNi_{1-b-c}Co_{b}M_{c}O₂₋ₐXₐ (wherein, 0.90≤a≤1, ≤b≤0.5, 0≤5c≤0.05, and 0<a<2); LiₐNi_{1-b-c}Co_{b}M_{c}O₂₋ₐX₂ (wherein, 0.90≤a≤1, 0≤b≤0.5, 0≤c≤0.05, and 0<a<2); LiₐNi_{1-b-c}Mn_{b}M_{c}Dₐ (wherein, 0.90≤a≤1, 0≤b≤0.5, 0≤c≤0.05, and 0<a≤2); LiₐNi_{1-b-c}Mn_{b}M_{c}O₂₋ₐXₐ (wherein, 0.90≤a≤1, 0≤b≤0.5, 0≤c≤0.05, and 0<a<2); LiₐNi_{1-b-c}Mn_{b}M_{c}O₂₋ₐX₂ (wherein, 0.90≤a≤1, 0≤b≤0.5, 0≤5≤0.05, and 0<a<2); LiₐNi_{b}E_{c}G_{d}O₂ (wherein, 0.90≤a≤1, 0≤b≤0.9, 0≤c≤0.5, and 0.001≤d≤0.1); LiₐNi_{b}Co_{c}Mn_{d}GeO₂ (wherein, 0.90≤a≤1, 0≤b≤0.9, 0≤c≤0.5, 0≤d≤0.5, and 0.001≤e≤0.1); LiₐNiG_{b}O₂ (wherein, 0.90≤a≤1 and 0.001≤b≤0.1); LiₐCoG_{b}O₂ (wherein, 0.90≤a≤1 and 0.001≤b≤0.1); LiₐMnG_{b}O₂ (wherein, 0.90≤a≤1 and 0.001≤b≤0.1); LiₐMn₂G_{b}O₄ (wherein, 0.90≤a≤1 and 0.001≤b≤0.1); QO₂; QS₂; LiQS₂; V₂O₅; LiV₂O₅; LiX′O₂; LiNiVO₄; Li_{(3-f)}J₂(PO₄)₃ (0≤f≤2); Li_{(3-f)}Fe₂(PO₄)₃ (0≤f≤2); and LiFePO₄. In the formulas above, A is Ni, Co, Mn, or a combination thereof; M is Al, Ni, Co, Mn, Cr, Fe, Mg, Sr, V, a rare-earth element, or a combination thereof; D is O, F, S, P, or a combination thereof; E is Co, Mn, or a combination thereof; X is F, S, P, or a combination thereof; G is Al, Cr, Mn, Fe, Mg, La, Ce, Sr, V, or a combination thereof; Q is Ti, Mo, Mn, or a combination thereof; X′ is Cr, V, Fe, Sc, Y, or a combination thereof; and J is V, Cr, Mn, Co, Ni, Cu, or a combination thereof. For example, LiCoO₂, LiMnₓO₂ₓ (x=1 or 2), LiNi₁₋ₓMnₓO₂ₓ (0<x<1), LiNi_{1-x-y}CoₓMn_{y}O₂ (0≤x≤0.5, 0≤y≤0.5), or FePO₄ may be used. In one embodiment, the cathodically active material comprises at least one of a lithium compound such as lithium cobalt oxide, lithium nickel oxide, lithium nickel cobalt oxide, lithium nickel cobalt aluminum oxide, lithium nickel cobalt manganese oxide, lithium manganese oxide, or lithium iron phosphate; nickel sulfide; copper sulfide; sulfur; iron oxide; or vanadium oxide.

In one embodiment, the cathodically active material can comprise a sodium containing material, such as at least one of an oxide of the formula NaM¹ₐO₂ such as NaFeO₂, NaMnO₂, NaNiO₂, or NaCoO₂; or an oxide represented by the formula NaMn₁₋ₐM¹ₐO₂, wherein M¹ is at least one transition metal element, and 0≤a<1. Representative positive active materials include Na[Ni_{1/2}Mn_{1/2}]O₂, Na_{2/3} [Fe_{1/2}Mn_{1/2}]O₂, and the like; an oxide represented by Na_{0.44}Mn₁₋ₐM¹ₐO₂, an oxide represented by Na_{0.7}Mn₁₋ₐM¹ₐ O_{2.05} an (wherein M¹ is at least one transition metal element, and 0≤a<1); an oxide represented by Na_{b}M²_{c}Si₁₂O₃₀ as Na₆Fe₂Si₁₂O₃₀ or Na₂Fe₅Si₁₂O (wherein M² is at least one transition metal element, 2≤b≤6, and 2≤c≤5); an oxide represented by Na_{d}M³ₑSi₆O₁₈ such as Na₂Fe₂Si₆O₁₁ or Na₂MnFeSi₆O₁₃ (wherein M³ is at least one transition metal element, 3≤d≤6, and 1≤e≤2); an oxide represented by Na_{f}M⁴_{g}Si₂O₆ such as Na₂FeSiO₆ (wherein M⁴ is at least one element selected from transition metal elements, magnesium (Mg) and aluminum (Al), 1≤f≤2 and 1≤g≤2); a phosphate such as NaFePO₄, Na₃Fe₂(PO₄)₃, Na₃V₂(PO₄)₃, Na₄Co₃(PO₄)₂P₂O₇ and the like; a borate such as NaFeBO₄ or Na₃Fe₂(BO₄)₃; a fluoride represented by NaₕM⁵F₆ such as Na₃FeF₆ or Na₂MnF₆ (wherein M⁵ is at least one transition metal element, and 2≤h≤3), a fluorophosphate such as Na₃V₂(PO₄)₂F₃, Na₃V₂(PO₄)₂FO₂ and the like. The positive active material is not limited to the foregoing and any suitable positive active material that is used in the art can be used. In an embodiment, the positive active material preferably comprises a layered-type oxide cathode material such as NaMnO₂, Na[Ni_{1/2}Mn_{1/2}]O₂ and Na_{2/3}[Fe_{1/2}Mns_{1/2}]O₂, a phosphate cathode such as Na₃V₂(PO₄)₃ and Na₄CO₃(PO₄)₂P₂O₇, or a fluorophosphate cathode such as Na₃V₂(PO₄)₂F₃ and Na₃V₂(PO₄)₂FO₂.

In one embodiment, the electrode current collector can comprise a negative electrode current collector, and can comprise a suitable conductive material, such as a metal material. For example, in one embodiment, the negative electrode current collector can comprise at least one of copper, nickel, aluminum, stainless steel, titanium, palladium, baked carbon, calcined carbon, indium, iron, magnesium, cobalt, germanium, lithium a surface treated material of copper or stainless steel with carbon, nickel, titanium, silver, an aluminum-cadmium alloy, and/or other alloys thereof. As another example, in one embodiment, the negative electrode current collector comprises at least one of copper, stainless steel, aluminum, nickel, titanium, baked carbon, a surface treated material of copper or stainless steel with carbon, nickel, titanium, silver, an aluminum-cadmium alloy, and/or other alloys thereof. In one embodiment, the negative electrode current collector comprises at least one of copper and stainless steel.

In one embodiment, the counter-electrode current collector can comprise a positive electrode current collector, and can comprise a suitable conductive material, such as a metal material. In one embodiment, the positive electrode current collector comprises at least one of stainless steel, aluminum, nickel, titanium, baked carbon, sintered carbon, a surface treated material of aluminum or stainless steel with carbon, nickel, titanium, silver, and/or an alloy thereof. In one embodiment, the positive electrode current collector comprises aluminum.

In yet another embodiment, the cathodically active material can further comprise one or more of a conductive aid and/or binder, which for example may be any of the conductive aids and/or binders described for the anodically active material herein.

According to certain embodiments, electrically insulating separator layers 130 may electrically isolate each member of the electrode structure 110 population from each member of the counter-electrode structure 112 population. The electrically insulating separator layers are designed to prevent electrical short circuits while also allowing the transport of ionic charge carriers that are needed to close the circuit during the passage of current in an electrochemical cell. In one embodiment, the electrically insulating separator layers are microporous and permeated with an electrolyte, e.g., a non-aqueous liquid or gel electrolyte. Alternatively, the electrically insulating separator layer may comprise a solid electrolyte, i.e., a solid ion conductor, which can serve as both a separator and the electrolyte in a battery.

In certain embodiments, electrically insulating separator layers 130 will typically include a microporous separator material that can be permeated with a non-aqueous electrolyte; for example, in one embodiment, the microporous separator material includes pores having a diameter of at least 50 Å, more typically in the range of about 2,500 Å, and a porosity in the range of about 25% to about 75%, more typically in the range of about 35-55%. Additionally, the microporous separator material may be permeated with a non-aqueous electrolyte to permit conduction of carrier ions between adjacent members of the electrode and counter-electrode populations. In certain embodiments, for example, and ignoring the porosity of the microporous separator material, at least 70 vol % of electrically insulating separator material between a member of the electrode structure 110 population and the nearest member(s) of the counter-electrode structure 112 population (i.e., an “adjacent pair”) for ion exchange during a charging or discharging cycle is a microporous separator material; stated differently, microporous separator material constitutes at least 70 vol % of the electrically insulating material between a member of the electrode structure 110 population and the nearest member of the counter-electrode 112 structure population.

In one embodiment, the microporous separator material comprises a particulate material and a binder, and has a porosity (void fraction) of at least about 20 vol. % The pores of the microporous separator material will have a diameter of at least 50 Å and will typically fall within the range of about 250 to 2,500 Å. The microporous separator material will typically have a porosity of less than about 75%. In one embodiment, the microporous separator material has a porosity (void fraction) of at least about 25 vol %. In one embodiment, the microporous separator material will have a porosity of about 35-55%.

The binder for the microporous separator material may be selected from a wide range of inorganic or polymeric materials. For example, in one embodiment, the binder can be an organic polymeric material such as a fluoropolymer derived from monomers containing vinylidene fluoride, hexafluoropropylene, tetrafluoropropene, and the like. In another embodiment, the binder is a polyolefin such as polyethylene, polypropylene, or polybutene, having any of a range of varying molecular weights and densities. In another embodiment, the binder is selected from the group consisting of ethylene-diene-propene terpolymer, polystyrene, polymethyl methacrylate, polyethylene glycol, polyvinyl acetate, polyvinyl butyral, polyacetal, and polyethyleneglycol diacrylate. In another embodiment, the binder is selected from the group consisting of methyl cellulose, carboxymethyl cellulose, styrene rubber, butadiene rubber, styrene-butadiene rubber, isoprene rubber, polyacrylamide, polyvinyl ether, polyacrylic acid, polymethacrylic acid, polyacrylonitrile, polyvinylidene fluoride polyacrylonitrile and polyethylene oxide. In another embodiment, the binder is selected from the group consisting of acrylates, styrenes, epoxies, and silicones. Other suitable binders may be selected from polyvinylidene fluoride-co-hexafluoropropylene, polyvinylidene fluoride-co-trichloroethylene, polymethylmethacrylate, polyacrylonitrile, polyvinylpyrrolidone, polyvinyl acetate, polyethylene-co-vinyl acetate, polyethylene oxide, cellulose acetate, cellulose acetate butyrate, cellulose acetate propionate, cyanoethylpullulan, cyanoethyl polyvinylalcohol, cyanoethylcellulose, cyanoethylsucrose, pullulan, carboxymethyl cellulose, acrylonitrile-styrene-butadiene copolymer, polyimide or mixtures thereof. In yet another embodiment, the binder may be selected from any of polyvinylidene fluoride-hexafluoro propylene, polyvinylidene fluoride-trichloroethylene, polymethyl methacrylate, polyacrylonitrile, polyvinyl pyrrolidone, polyvinyl acetate, ethylene vinyl acetate copolymer, polyethylene oxide, cellulose acetate, cellulose acetate butyrate, cellulose acetate propionate, cyanoethyl pullulan, cyanoethyl polyvinyl alcohol, cyanoethyl cellulose, cyanoethyl sucrose, pullulan, carboxyl methyl cellulose, acrylonitrile styrene butadiene copolymer, polyimide, polyethylene terephthalate, polybutylene terephthalate, polyester, polyacetal, polyamide, polyetheretherketone, polyether sulfone, polyphenylene oxide, polyphenylene sulfide, polyethylene naphthalene, and/or combinations thereof. In another embodiment, the binder is a copolymer or blend of two or more of the aforementioned polymers.

The particulate material comprised by the microporous separator material may also be selected from a wide range of materials. In general, such materials have a relatively low electronic and ionic conductivity at operating temperatures and do not corrode under the operating voltages of the battery electrode or current collector contacting the microporous separator material. For example, in one embodiment, the particulate material has a conductivity for carrier ions (e.g., lithium) of less than 1×10⁻⁴ S/cm. By way of further example, in one embodiment, the particulate material has a conductivity for carrier ions of less than 1×10⁻⁵ S/cm. By way of further example, in one embodiment, the particulate material has a conductivity for carrier ions of less than 1×10⁻⁶ S/cm. For example, in one embodiment, the binder is an organic material selected from the group consisting of silicates, phosphates, aluminates, aluminosilicates, and hydroxides such as magnesium hydroxide, calcium hydroxide, etc. Exemplary particulate materials include particulate polyethylene, polypropylene, a TiO₂-polymer composite, silica aerogel, fumed silica, silica gel, silica hydrogel, silica xerogel, silica sol, colloidal silica, alumina, titania, magnesia, kaolin, talc, diatomaceous earth, calcium silicate, aluminum silicate, calcium carbonate, magnesium carbonate, or a combination thereof. For example, in one embodiment, the particulate material comprises a particulate oxide or nitride such as TiO₂, SiO₂, Al₂O₃, GeO₂, B₂O₃, Bi₂O₃, BaO, ZnO, ZrO₂, BN, Si₃N₄, Ge₃N₄. See, for example, P. Arora and J. Zhang, “Battery Separators” Chemical Reviews 2004, 104, 4419-4462). Other suitable particles can comprise BaTiO₃, Pb(Zr,Ti)O₃ (PZT), Pb₁₋ₓLaₓZr_{1-y}Ti_{y}O₃ (PLZT), PB(Mg₃Nb_{2/3})O₃—PbTiO₃ (PMN-PT), hafnia (HfO₂), SrTiO₃, SnO₂, CeO₂, MgO, NiO, CaO, ZnO, ZrO₂, Y₂O₃, Al₂O₃, TiO₂, SiC or mixtures thereof. In one embodiment, the particulate material will have an average particle size of about 20 nm to 2 micrometers, more typically 200 nm to 1.5 micrometers. In one embodiment, the particulate material will have an average particle size of about 500 nm to 1 micrometer.

According to one embodiment of an assembled energy storage device, the microporous separator material is permeated with a non-aqueous electrolyte suitable for use as a secondary battery electrolyte. Typically, the non-aqueous electrolyte comprises a lithium salt and/or mixture of salts dissolved in an organic solvent and/or solvent mixture. Exemplary lithium salts include inorganic lithium salts such as LiClO₄, LiBF₄, LiPF₆, LiAsF₆, LiCl, and LiBr; and organic lithium salts such as LiB(C₆H₅)₄, LiN(SO₂CF₃)₂, LiN(SO₂CF₃)₃, LiNSO₂CF₃, LiNSO₂CF₅, LiNSO₂C₄F₉, LiNSO₂C₅F₁₁, LiNSO₂C₆F₁₃, and LiNSO₂C₇F₁₅. As yet another example, the electrolyte can comprise sodium ions dissolved therein, such as for example any one or more of NaClO₄, NaPF₆, NaBF₄, NaCF₃SO₃, NaN(CF₃SO₂)₂, NaN(C₂F₅SO₂)₂, NaC(CF₃SO₂)₃ Salts of magnesium and/or potassium can similarly be provided. For example magnesium salts such as magnesium chloride (MgCl₂), magnesium bromide MgBr₂), or magnesium iodide (MgI₂) may be provided, and/or as well as a magnesium salt that may be at least one selected from the group consisting of magnesium perchlorate (Mg(ClO₄)₂), magnesium nitrate (Mg(NO₃)₂), magnesium sulfate (MgSO₄), magnesium tetrafluoroborate (Mg(BF₄)₂), magnesium tetraphenylborate (Mg(B(C₆H₅)₄)₂, magnesium hexafluorophosphate (Mg(PF₆)₂), magnesium hexafluoroarsenate (Mg(AsF₆)₂), magnesium perfluoroalkylsulfonate ((Mg(R_{f1}SO₃)₂), in which R_{f1} is a perfluoroalkyl group), magnesium perfluoroalkylsulfonylimide (Mg((R_{f2}SO₂)₂N)₂, in which R_{f2} is a perfluoroalkyl group), and magnesium hexaalkyl disilazide ((Mg(HRDS)₂), in which R is an alkyl group). Exemplary organic solvents to dissolve the lithium salt include cyclic esters, chain esters, cyclic ethers, and chain ethers. Specific examples of the cyclic esters include propylene carbonate, ethylene carbonate, butylene carbonate, γ-butyrolactone, vinylene carbonate, 2-methyl-γ-butyrolactone, acetyl-γ-butyrolactone, and γ-valerolactone. Specific examples of the chain esters include dimethyl carbonate, diethyl carbonate, dibutyl carbonate, dipropyl carbonate, methyl ethyl carbonate, methyl butyl carbonate, methyl propyl carbonate, ethyl butyl carbonate, ethyl propyl carbonate, butyl propyl carbonate, alkyl propionates, dialkyl malonates, and alkyl acetates. Specific examples of the cyclic ethers include tetrahydrofuran, alkyltetrahydrofurans, dialkyltetrahydrofurans, alkoxytetrahydrofurans, dialkoxytetrahydrofurans, 1,3-dioxolane, alkyl-1,3-dioxolanes, and 1,4-dioxolane. Specific examples of the chain ethers include 1,2-dimethoxyethane, 1,2-diethoxythane, diethyl ether, ethylene glycol dialkyl ethers, diethylene glycol dialkyl ethers, triethylene glycol dialkyl ethers, and tetraethylene glycol dialkyl ethers.

In yet another embodiment, the electrically insulating separator 130 comprises a solid electrolyte, for example as in a solid state battery. Generally speaking, the solid electrolyte can facilitate transport of carrier ions, without requiring addition of a liquid or gel electrolyte. According to certain embodiments, in a case where a solid electrolyte is provided, the solid electrolyte may itself be capable of providing insulation between the electrodes and allowing for passage of carrier ions therethrough, and may not require addition of a liquid electrolyte permeating the structure.

In one embodiment, the secondary battery 102 can comprise electrolyte that may be any of an organic liquid electrolyte, an inorganic liquid electrolyte, an aqueous electrolyte, a non-aqueous electrolyte, a solid polymer electrolyte, a solid ceramic electrolyte, a solid glass electrolyte, a garnet electrolyte, a gel polymer electrolyte, an inorganic solid electrolyte, a molten-type inorganic electrolyte or the like. Other arrangements and/or configurations of electrically insulating separator 130, with or without liquid electrolyte, may also be provided. In one embodiment, the solid electrolyte can comprise a ceramic or glass material that is capable of providing electrical insulation while also conducting carrier ions therethrough. Examples of ion conducting material can include garnet materials, a sulfide glass, a lithium ion conducting glass ceramic, or a phosphate ceramic material. For example, the solid electrolyte can comprise a ceramic or glass material that is capable of providing electrical insulation while also conducting carrier ions therethrough. Examples of ion conducting material can include garnet materials, a sulfide glass, a lithium ion conducting glass ceramic, or a phosphate ceramic material. In one embodiment, a solid polymer electrolyte can comprise any of a polymer formed of polyethylene oxide (PEO)-based, polyvinyl acetate (PVA)-based, polyethyleneimine (PEI)-based, polyvinylidene fluoride (PVDF)-based, polyacrylonitrile (PAN)-based, LiPON, and polymethyl methacrylate (PMMA)-based polymers or copolymers thereof. In another embodiment, a sulfide-based solid electrolyte may be provided, such as a sulfide-based solid electrolyte comprising at least one of lithium and/or phosphorous, such as at least one of Li₂S and P₂S₅, and/or other sulfides such as SiS₂, GeS₂, Li₃PS₄, Li₄P₂S₇, Li₄SiS₄, Li₂S—P₂S₅, and 50Li₄SiO₄·50Li₃BO₃, and/or B₂S₃. Yet other embodiments of solid electrolyte can include nitrides, halides and sulfates of lithium (Li) such as Li₃N, LiI, Li₅N₁₂, Li₃N—LiI—LiOH, LiSiO₄, LiSiO₄—LiI—LiOH, Li₂SiS₃, Li₄SiO₄, Li₄SiO₄—LiI—LiOH, and Li₃PO₄—Li₂S—SiS₂, Li₂S—P₂S₅, Li₂S—P₂S₅-L₄SiO₄, Li₂S—Ga₂S₃—GeS₂, Li₂S—Sb₂S₃—GeS₂, Li_{3.25}—Ge_{0.25}—P_{0.75}S₄, (La,Li)TiO₃ (LLTO), Li₆La₂CaTa₂O₁₂, Li₆La₂ANb₂O₁₂(A=Ca, Sr), Li₂Nd₃TeSbO₁₂, Li₃BO_{2.5}N_{0.5}, Li₉SiAlO₈, Li₁₊ₓAlₓGe₂₋ₓ(PO₄)₃ (LAGP), Li₁₊ₓAlₓTi₂₋ₓ(PO₄)₃ (LATP), Li₁₊ₓTi₂₋ₓAlₓSi_{y}(PO₄)_{3-y}, LiAlₓZr₂₋ₓ(PO₄)₃, LiTiₓZr₂₋ₓ(PO₄)₃, Yet other embodiments of solid electrolyte can include garnet materials, such as for example described in U.S. Pat. No. 10,361,455, which is hereby incorporated herein in its entirety. In one embodiment, the garnet solid electrolyte is a nesosilicate having the general formula X₃Y₂(SiO₄)₃, where X may be a divalent cation such as Ca, Mg, Fe or Mn, or Y may be a trivalent cation such as Al, Fe, or Cr.

### EMBODIMENTS

The enumerated embodiments 1-158 below set forth embodiments according to the disclosure.

Embodiment 1: A method for transferring carrier ions from an auxiliary electrode comprising a source of carrier ions to an electrode assembly through a constraint system, wherein
the electrode assembly comprises a population of unit cells stacked in series in a stacking direction, wherein (i) each unit cell comprises an electrode structure, a counter-electrode structure, and an electrically insulating separator between the electrode and counter-electrode structures, (ii) the electrode structures, counter-electrode structures and electrically insulating separators within each unit cell have opposing upper and lower end surfaces separated in a vertical direction, (iii) the vertical direction is orthogonal to the stacking direction,
the electrode assembly is enclosed within a volume defined by the constraint system, the constraint system comprising (i) first and second primary growth constraints separated in the stacking direction, and (ii) first and second secondary growth constraints separated in the vertical direction and connecting the first and second primary growth constraints, wherein (iii) the first secondary growth constraint is further connected to the upper end surface(s) of the electrode or counter-electrode structures of a subset of members of the unit cell population, (iv) the second secondary growth constraint is further connected to the lower end surface(s) of the electrode or counter-electrode structures of a subset of members of the unit cell population, (v) the first or second secondary growth constraint comprises a plurality of apertures through a vertical thickness thereof, and a porous electrically insulating material disposed within the plurality of apertures, the porous electrically insulating material providing a path for carrier ions through the apertures, the porous electrically insulating material having a porosity,
the auxiliary electrode is located outside the volume enclosed by the constraint system, and
the method comprises transferring carrier ions from the auxiliary electrode through the porous electrically insulating material within the apertures to members of the unit cell population.

Embodiment 2: An electrode assembly comprising a constraint system for a secondary battery, the electrode assembly comprising:
a population of unit cells stacked in series in a stacking direction, wherein (i) each unit cell comprises an electrode structure, a counter-electrode structure, and an electrically insulating separator between the electrode and counter-electrode structures, (ii) the electrode structures, counter-electrode structures and electrically insulating separators within each unit cell have opposing upper and lower end surfaces separated in a vertical direction, (iii) the vertical direction is orthogonal to the stacking direction,
wherein the electrode assembly is enclosed within a volume defined by the constraint system, the constraint system comprising (i) first and second primary growth constraints separated in the longitudinal direction, and (ii) first and second secondary growth constraints separated in the vertical direction and connecting the first and second primary growth constraints, wherein (iii) the first secondary growth constraint is further connected to the upper end surfaces of the electrode or counter-electrode structures of a subset of the unit cell population, (iv) the second secondary growth constraint is further connected to the lower end surfaces of the electrode or counter-electrode structures of a subset of the unit cell population, (v) the first or second secondary growth constraint comprises a plurality of apertures through a vertical thickness thereof, and a porous electrically insulating material disposed within the plurality of apertures, the porous electrically insulating material providing a path for carrier ions through the apertures, the electrically insulating material having a porosity.

Embodiment 3: A secondary battery comprising the electrode assembly of Embodiment 2.

Embodiment 4: The method, electrode assembly, or secondary battery according to any of Embodiments 1-3, wherein both the first and second secondary growth constraints comprise the plurality of apertures.

Embodiment 5: The method according to any one of Embodiments 1 or 4, comprising aligning the auxiliary electrode over apertures in the first or second secondary growth constraint, and applying a pressure in a range of greater than 0 psi to no more than 20 psi to press the auxiliary electrode and the first or second secondary growth constraint against one another.

Embodiment 6: The method according to any of Embodiments 1 and 4-5, comprising applying a pressure in a range of greater than 5 psi to no more than 20 psi to press the auxiliary electrode and the first or second secondary growth constraint against one another.

Embodiment 7: The method according to any of Embodiments 1 and 4-6, wherein the pressure is applied to contact the auxiliary electrode with porous electrically insulating material disposed in the apertures.

Embodiment 8: The method according to any of Embodiments 1 and 4-7, wherein carrier ions are transferred to achieve and/or restore a predetermined counter-electrode structure end of discharge voltage V_{ces eod}, and a predetermined electrode structure end of discharge voltage V_{es,eod}.

Embodiment 9: The method according to any of Embodiments 1 and 4-8, wherein the carrier ions are transferred to replenish carrier ions lost to the formation of SEI.

Embodiment 10: The method according to any of Embodiments 1 and 4-9, wherein the carrier ions are transferred to replenish carrier ions lost to the formation of SEI.

Embodiment 11: The method according to any of Embodiments 1 and 4-10, wherein the carrier ions are transferred to compensate for a loss of carrier ions during an initial or subsequent charging cycle of the electrode assembly.

Embodiment 12: The method according to any of Embodiments 1 and 4-11, wherein the method comprises (i) transferring carrier ions from counter-electrode structures to electrode structures in the unit cell population during an initial or subsequent charging cycle to at least partially charge the electrode assembly, and (ii) transferring carrier ions from the auxiliary electrode, to counter-electrode structures and/or electrode structures, through the porous electrically insulating material, the auxiliary electrode being electrolytically coupled to the counter-electrode structure and/or electrode structure of members of the unit cell population, through the separator, to provide the electrode assembly with the predetermined counter-electrode structure end of discharge voltage V_{cos,eod}, and the predetermined electrode structure end of discharge voltage V_{es,eod}.

Embodiment 13: The method according to Embodiment 12, wherein the method further comprises (iii) transferring, after (ii), carrier ions from the counter-electrode structure to the electrode structure of members of the unit cell population to charge the electrode assembly.

Embodiment 14: The method according to Embodiment 13, wherein (ii) is performed simultaneously with (i).

Embodiment 15: The method according to any of Embodiments 12-14 comprising, in (ii), applying a bias voltage between the auxiliary electrode and the electrode structure or counter-electrode structure of members of the unit cell population to provide a flow of carrier ions through the porous electrically insulating material.

Embodiment 16: The method, electrode assembly, or secondary battery of any preceding Embodiment, wherein the electrode structures of the members of the unit cell population comprise electrode active material layers and electrode current collector layers, and the counter-electrode structures of members of the unit cell population comprise counter-electrode active material layers and counter-electrode current collector layers.

Embodiment 17: The method, electrode assembly, or secondary battery of any preceding Embodiment, wherein the porous electrically insulating material comprises a porosity of at least 25%.

Embodiment 18: The method, electrode assembly, or secondary battery of any preceding Embodiment, wherein the porous electrically insulating material comprises a porosity of at least 30%.

Embodiment 19: The method, electrode assembly, or secondary battery of any preceding Embodiment, wherein the porous electrically insulating material comprises a porosity of at least 35%.

Embodiment 20: The method, electrode assembly, or secondary battery of any preceding Embodiment, wherein the porous electrically insulating material comprises a porosity of at least 40%.

Embodiment 21: The method, electrode assembly, or secondary battery of any preceding Embodiment, wherein the porous electrically insulating material comprises a porosity of at least 45%.

Embodiment 22: The method, electrode assembly, or secondary battery of any preceding Embodiment, wherein the porous electrically insulating material comprises a porosity of at least 50%.

Embodiment 23: The method, electrode assembly, or secondary battery of any preceding Embodiment, wherein the porous electrically insulating material comprises a porosity of at least 55%.

Embodiment 24: The method, electrode assembly, or secondary battery of any preceding Embodiment, wherein the porous electrically insulating material comprises a porosity of no more than 55%.

Embodiment 25: The method, electrode assembly, or secondary battery of any preceding Embodiment, wherein the porous electrically insulating material comprises a porosity of no more than 50%.

Embodiment 26: The method, electrode assembly, or secondary battery of any preceding Embodiment, wherein the porous electrically insulating material comprises a porosity of no more than 45%.

Embodiment 27: The method, electrode assembly, or secondary battery of any preceding Embodiment, wherein the porous electrically insulating material comprises a porosity of no more than 40%.

Embodiment 28: The method, electrode assembly, or secondary battery of any preceding Embodiment, wherein the porous electrically insulating material comprises a porosity of no more than 35%.

Embodiment 29: The method, electrode assembly, or secondary battery of any preceding Embodiment, wherein the electrically insulating separator is microporous and a ratio of the porosity of the porous electrically insulating material to a porosity of the electrically insulating separator is in a range of from 1:0.75 to 1:1.5.

Embodiment 30: The method, electrode assembly, or secondary battery of any preceding Embodiment, wherein the porous electrically insulating material comprises a particulate material dispersed in a binder material.

Embodiment 31: The method, electrode assembly, or secondary battery of Embodiment 30, wherein the particulate material comprises a stable metal oxide or ceramic.

Embodiment 32: The method, electrode assembly, or secondary battery of any of Embodiments 30-31, wherein the particulate material comprises any one or more of alumina, boron nitride, titania, silica, zirconia, magnesium oxide and calcium oxide.

Embodiment 33: The method, electrode assembly, or secondary battery of any of Embodiments 30-32, wherein the particulate material comprises alumina.

Embodiment 34: The method, electrode assembly, or secondary battery of any of Embodiments 30-33, wherein the particulate material comprises particles having a d50 particle size (median particle size) of at least 0.35 microns.

Embodiment 35: The method, electrode assembly, or secondary battery of any of Embodiments 30-34, wherein the particulate material comprises particles having a d50 particle size (median particle size) of at least 0.45 microns.

Embodiment 36: The method, electrode assembly, or secondary battery of any of Embodiments 30-35, wherein the particulate material comprises particles having a d50 particle size (median particle size) of at least 0.5 microns.

Embodiment 37: The method, electrode assembly, or secondary battery of any of Embodiments 30-36, wherein the particulate material comprises particles having a d50 particle size (median particle size) of at least 0.75 microns.

Embodiment 38: The method, electrode assembly, or secondary battery of any of Embodiments 30-37, wherein the particulate material comprises particles having a d50 particle size (median particle size) of no more than 40 microns.

Embodiment 39: The method, electrode assembly, or secondary battery of any of Embodiments 30-38, wherein the particulate material comprises particles having a d50 particle size (median particle size) of no more than 35 microns.

Embodiment 40: The method, electrode assembly, or secondary battery of any of Embodiments 30-39, wherein the particulate material comprises particles having a d50 particle size (median particle size) of no more than 25 microns.

Embodiment 41: The method, electrode assembly, or secondary battery of any of Embodiments 30-40, wherein the particulate material comprises particles having a d50 particle size (median particle size) of no more than 20 microns.

Embodiment 42: The method, electrode assembly, or secondary battery of any of Embodiments 30-41, wherein at least 80% by weight of the particles have a particle size of at least 0.35 microns.

Embodiment 43: The method, electrode assembly, or secondary battery of any of Embodiments 30-42, wherein at least 85% by weight of the particles have a particle size of at least 0.35 microns.

Embodiment 44: The method, electrode assembly, or secondary battery of any of Embodiments 30-43, wherein at least 90% by weight of the particles have a particle size of at least 0.35 microns.

Embodiment 45: The method, electrode assembly, or secondary battery of any of Embodiments 30-44, wherein at least 95% by weight of the particles have a particle size of at least 0.35 microns.

Embodiment 46: The method, electrode assembly, or secondary battery of any of Embodiments 30-45, wherein at least 80% by weight of the particles have a particle size of at least 0.45 microns.

Embodiment 47: The method, electrode assembly, or secondary battery of any of Embodiments 30-46, wherein at least 85% by weight of the particles have a particle size of at least 0.45 microns.

Embodiment 48: The method, electrode assembly, or secondary battery of any of Embodiments 30-47, wherein at least 90% by weight of the particles have a particle size of at least 0.45 microns.

Embodiment 49: The method, electrode assembly, or secondary battery of any of Embodiments 30-48, wherein at least 95% by weight of the particles have a particle size of at least 0.45 microns.

Embodiment 50: The method, electrode assembly, or secondary battery of any of Embodiments 30-49, wherein at least 80% by weight of the particles have a particle size of at least 0.5 microns.

Embodiment 51: The method, electrode assembly, or secondary battery of any of Embodiments 30-50, wherein at least 85% by weight of the particles have a particle size of at least 0.5 microns.

Embodiment 52: The method, electrode assembly, or secondary battery of any of Embodiments 30-51, wherein at least 90% by weight of the particles have a particle size of at least 0.5 microns.

Embodiment 53: The method, electrode assembly, or secondary battery of any of Embodiments 30-52, wherein at least 95% by weight of the particles have a particle size of at least 0.5 microns.

Embodiment 54: The method, electrode assembly, or secondary battery of any of Embodiments 30-53, wherein at least 80% by weight of the particles have a particle size of at least 0.75 microns.

Embodiment 55: The method, electrode assembly, or secondary battery of any of Embodiments 30-54, wherein at least 85% by weight of the particles have a particle size of at least 0.75 microns.

Embodiment 56: The method, electrode assembly, or secondary battery of any of Embodiments 30-55, wherein at least 90% by weight of the particles have a particle size of at least 0.75 microns.

Embodiment 57: The method, electrode assembly, or secondary battery of any of Embodiments 30-56, wherein at least 95% by weight of the particles have a particle size of at least 0.75 microns.

Embodiment 58: The method, electrode assembly, or secondary battery of any of Embodiments 30-57, wherein at least 80% by weight of the particles have a particle size of no more than 40 microns.

Embodiment 59: The method, electrode assembly, or secondary battery of any of Embodiments 30-58, wherein at least 85% by weight of the particles have a particle size of no more than 40 microns.

Embodiment 60: The method, electrode assembly, or secondary battery of any of Embodiments 30-59, wherein at least 90% by weight of the particles have a particle size of no more than 40 microns.

Embodiment 61: The method, electrode assembly, or secondary battery of any of Embodiments 30-60, wherein at least 95% by weight of the particles have a particle size of no more than 40 microns.

Embodiment 62: The method, electrode assembly, or secondary battery of any of Embodiments 30-61, wherein at least 80% by weight of the particles have a particle size of no more than 35 microns.

Embodiment 63: The method, electrode assembly, or secondary battery of any of Embodiments 30-62, wherein at least 85% by weight of the particles have a particle size of no more than 35 microns.

Embodiment 64: The method, electrode assembly, or secondary battery of any of Embodiments 30-63, wherein at least 90% by weight of the particles have a particle size of no more than 35 microns.

Embodiment 65: The method, electrode assembly, or secondary battery of any of Embodiments 30-64, wherein at least 95% by weight of the particles have a particle size of no more than 35 microns.

Embodiment 66: The method, electrode assembly, or secondary battery of any of Embodiments 30-65, wherein at least 80% by weight of the particles have a particle size of no more than 25 microns.

Embodiment 67: The method, electrode assembly, or secondary battery of any of Embodiments 30-66, wherein at least 85% by weight of the particles have a particle size of no more than 25 microns.

Embodiment 68: The method, electrode assembly, or secondary battery of any of Embodiments 30-67, wherein at least 90% by weight of the particles have a particle size of no more than 25 microns.

Embodiment 69: The method, electrode assembly, or secondary battery of any of Embodiments 30-68, wherein at least 95% by weight of the particles have a particle size of no more than 25 microns.

Embodiment 70: The method, electrode assembly, or secondary battery of any of Embodiments 30-69, wherein at least 80% by weight of the particles have a particle size of no more than 20 microns.

Embodiment 71: The method, electrode assembly, or secondary battery of any of Embodiments 30-70, wherein at least 85% by weight of the particles have a particle size of no more than 25 microns.

Embodiment 72: The method, electrode assembly, or secondary battery of any of Embodiments 30-71, wherein at least 90% by weight of the particles have a particle size of no more than 25 microns.

Embodiment 73: The method, electrode assembly, or secondary battery of any of Embodiments 30-72, wherein at least 95% by weight of the particles have a particle size of no more than 25 microns.

Embodiment 74: The method, electrode assembly, or secondary battery of any of Embodiments 30-73, wherein the particulate material comprises at least 70 wt % of the porous electrically insulating material.

Embodiment 75: The method, electrode assembly, or secondary battery of any of Embodiments 30-74, wherein the particulate material comprises at least 75 wt % of the porous electrically insulating material.

Embodiment 76: The method, electrode assembly, or secondary battery of any of Embodiments 30-75, wherein the particulate material comprises at least 80 wt % of the porous electrically insulating material.

Embodiment 77: The method, electrode assembly, or secondary battery of any of Embodiments 30-76, wherein the particulate material comprises at least 85 wt % of the porous electrically insulating material.

Embodiment 78: The method, electrode assembly, or secondary battery of any of Embodiments 30-77, wherein the particulate material comprises no more than 99.5 wt % of the porous electrically insulating material.

Embodiment 79: The method, electrode assembly, or secondary battery of any of Embodiments 30-78, wherein the particulate material comprises no more than 97 wt % of the porous electrically insulating material.

Embodiment 80: The method, electrode assembly, or secondary battery of any of Embodiments 30-79, wherein the particulate material comprises no more than 95 wt % of the porous electrically insulating material.

Embodiment 81: The method, electrode assembly, or secondary battery of any of Embodiments 30-80, wherein the particulate material comprises no more than 90 wt % of the porous electrically insulating material.

Embodiment 82: The method, electrode assembly, or secondary battery of any of Embodiments 30-81, wherein the binder material comprises a polymeric material selected from any of the group consisting of polyvinylidene fluoride (PVDF), polyethylene, polypropylene, ethylene acrylic acid (EAA), ethylene methacrylic acid (EMAA), and copolymers thereof.

Embodiment 83: The method, electrode assembly, or secondary battery of any preceding Embodiment, wherein the electrode assembly has mutually perpendicular transverse, longitudinal and vertical axes corresponding to the x, y and z axes, respectively, of an imaginary three-dimensional Cartesian coordinate system, a first longitudinal end surface and a second longitudinal end surface separated from each other in the longitudinal direction, and a lateral surface surrounding an electrode assembly longitudinal axis A_{EA} and connecting the first and second longitudinal end surfaces, the lateral surface having opposing first and second regions on opposite sides of the longitudinal axis and separated in a first direction that is orthogonal to the longitudinal axis, the electrode assembly having a maximum width W_{EA} measured in the longitudinal direction, a maximum length L_{EA} bounded by the lateral surface and measured in the transverse direction, and a maximum height H_{EA} bounded by the lateral surface and measured in the vertical direction, and further wherein
each electrode structure of members of the unit cell population comprise a length L_{E} as measured in the transverse direction between first and second opposing transverse end surfaces of the electrode structure, and a height H_{E} as measured in the vertical direction between first and second opposing vertical end surfaces of the electrode structure, and a width W_{E} as measured in the longitudinal direction between first and second opposing surfaces of the electrode structure, and each counter-electrode structure of members of the unit cell population comprises a length L_{CE} as measured in the transverse direction between first and second opposing transverse end surfaces of the counter-electrode structure, a height H_{CE} as measured in the vertical direction between first and second opposing vertical end surfaces of the counter-electrode structure, and a width W_{CE} as measured in the longitudinal direction between first and second opposing surfaces of the counter-electrode structure, and
wherein the ratio of L_{E} to each of W_{E} and H_{E} is at least 5:1, respectively, and a ratio of H_{E} to W_{E} is in the range of about 2:1 to about 100:1, for electrode structures of members of the unit cell population, and the ratio of L_{CE} to each of W_{CE} and H_{CE} is at least 5:1, respectively, and a ratio of H_{CE} to W_{CE} is in the range of about 2:1 to about 100:1, for counter-electrode structures of members of the unit cell population.

Embodiment 84: The method, electrode assembly, or secondary battery of Embodiment 83, wherein the porous electrically insulating material extends at least 50% of the counter-electrode structure of members of the unit cell population.

Embodiment 85: The method, electrode assembly, or secondary battery of any of Embodiments 83-84, wherein the porous electrically insulating material extends at least 60% of the counter-electrode structure of members of the unit cell population.

Embodiment 86: The method, electrode assembly, or secondary battery of any of Embodiments 83-85, wherein the porous electrically insulating material extends at least 75% of the counter-electrode structure of members of the unit cell population.

Embodiment 87: The method, electrode assembly, or secondary battery of any of Embodiments 83-86, wherein the porous electrically insulating material extends at least 85% of the counter-electrode structure of members of the unit cell population.

Embodiment 88: The method, electrode assembly, or secondary battery of any of Embodiments 83-87, wherein the porous electrically insulating material extends at least 90% of the counter-electrode structure of members of the unit cell population.

Embodiment 89: The method, electrode assembly, or secondary battery of any preceding Embodiment, wherein the constraint system comprises a primary growth constraint system comprising the first and second primary growth constraints and at least one primary connecting member, the first and second primary growth constraints separated from each other in the stacking direction, and the at least one primary connecting member connecting the first and second primary growth constraints, wherein the primary growth constraint system restrains growth of the electrode assembly in the stacking direction.

Embodiment 90: The method, electrode assembly, or secondary battery of any preceding Embodiment, wherein the constraint system comprises a secondary growth constraint system comprising the first and second secondary growth constraints separated in the vertical direction and connected to electrode current collectors of members of the population of electrode structures, wherein the secondary growth constraint system at least partially restrains growth of the electrode assembly in the vertical direction upon cycling of the electrode assembly.

Embodiment 91. The electrode assembly or secondary battery of any preceding Embodiment, wherein (i) the electrode structures are anode structures and the counter-electrode structures are cathode structures, or (ii) the electrode structures are cathode structures and the counter-electrode structures are anode structures.

Embodiment 92. The electrode assembly or secondary battery of Embodiment 91, wherein the electrode structures are anode structures comprising anodically active material layers, and the counter-electrode structures are cathode structures comprising cathodically active material layers.

Embodiment 93: The method, electrode assembly, or secondary battery of any preceding Embodiment, wherein the plurality of apertures comprise a plurality of slots spaced apart from one another in a transverse direction that is orthogonal to the stacking direction and the vertical direction, each slot having a longitudinal axis oriented in the stacking direction, and wherein each slot extends across a plurality of members of the unit cell population.

Embodiment 94: The method, electrode assembly, or secondary battery of Embodiment 93, wherein the plurality of slots are substantially filled with the porous electrically insulating material.

Embodiment 95: The method, electrode assembly, or secondary battery of any preceding Embodiment, wherein the porous electrically insulating material substantially fills any apertures in the first and/or second secondary growth constraints that form a portion of the path for the carrier ions from the auxiliary electrode to members of the unit cell population.

Embodiment 96: The method, electrode assembly, or secondary battery of any preceding Embodiment, wherein porous electrically insulating material further covers the upper or lower end surface(s) of the electrode or the counter-electrode structure(s) of the members of the unit cell population.

Embodiment 97: The method, electrode assembly, or secondary battery of any preceding Embodiment, wherein porous electrically insulating material further covers both the upper and lower end surface(s) of the electrode or the counter-electrode structure(s) of the members of the unit cell population.

Embodiment 98: The method, electrode assembly, or secondary battery of any preceding Embodiment, wherein members of the unit cell population have upper and lower edge margins that comprise the opposing upper and lower end surfaces, wherein upper end surfaces of the electrode and counter-electrode structures within a same unit cell population member are vertically offset from one another to form an upper recess, and lower end surfaces of the electrode and counter-electrode structures within a same unit cell population member are vertically offset from one another to form a lower recess, wherein the counter-electrode upper and lower end surfaces are recessed inwardly with respect to the respective electrode upper and lower end surfaces within the same until cell population member, and wherein porous electrically insulating material is located within at least one of the upper and lower recess.

Embodiment 99: The method, electrode assembly, or secondary battery of Embodiment 98, wherein porous electrically insulating material substantially fills regions of the upper and lower recesses that are inwardly disposed with respect to the upper and lower end surfaces of the electrode structure population in members of the unit cell population, and that are abutting a side of the electrically insulating separator facing the counter-electrode structure.

Embodiment 100: The method, electrode assembly, or secondary battery of any of Embodiments 98-99, wherein the porous electrically insulating material covering the upper or lower end surface(s) of the electrode or counter-electrode structures, and the porous electrically insulating material disposed in the apertures of the first or second secondary growth constraint, form a continuous ion-conducting path for carrier ions from the auxiliary electrode to members of the unit cell population.

Embodiment 101: The method, electrode assembly, or secondary battery of any preceding Embodiment, wherein the electrode assembly is contained with a sealed battery enclosure.

Embodiment 102: The method, electrode assembly, or secondary battery of Embodiment 101, wherein carrier ions and the constraint system are contained within the sealed battery enclosure.

Embodiment 103: The method, electrode assembly, or secondary battery of any preceding embodiment, wherein the electrode structure comprises an anode active material comprising any one of more of carbon materials, graphite, soft or hard carbons, metals, semi-metals, alloys, oxides, compounds capable of forming an alloy with lithium, tin, lead, magnesium, aluminum, boron, gallium, silicon, Si/C composites, Si/graphite blends, SiOx, porous Si, intermetallic Si alloys, indium, zirconium, germanium, bismuth, cadmium, antimony, silver, zinc, arsenic, hafnium, yttrium, lithium, sodium, lithium titanate, palladium, lithium metals, carbon, petroleum cokes, activated carbon, graphite, silicon compounds, silicon alloys, tin compounds, non-graphitizable carbon, graphite-based carbon, LiₓFe₂O₃ (0≤x≤1), LiₓWO₂ (0≤x≤1), SnₓMe₁₋ₓMe′_{y}O_{z} (Me: Mn, Fe, Pb, Ge; Me′: Al, B, P, Si, elements found in Group 1, Group 2 and Group 3 in a periodic table, halogen; 0<x≤1; 1≤y≤3; 1≤z≤8), a lithium alloy, a silicon-based alloy, a tin-based alloy; a metal oxide, SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, Bi₂O₅, a conductive polymer, polyacetylene, Li—Co—Ni-based material, crystalline graphite, natural graphite, synthetic graphite, amorphous carbon, Kish graphite, pyrolytic carbon, mesophase pitch-based carbon fibers, meso-carbon microbeads, mesophase pitches, graphitized carbon fiber, high-temperature sintered carbon, petroleum, coal tar pitch derived cokes, tin oxide, titanium nitrate, lithium metal film, an alloy of lithium and one or more types of metals selected from the group consisting of Na, K, Rb, Cs, Fr, Be, Mg, Ca, Sr, Ba, Ra, Al and Sn, a metal compound capable of alloying and/or intercalating with lithium selected from any of Si, Al, C, Pt, Sn, Pb, Ir, Ni, Cu, Ti, Na, K, Rb, Cs, Fr, Be, Ca, Sr, Sb, Ba, Ra, Ge, Zn, Bi, In, Mg, Ga, Cd, a Sn alloy, an Al alloy, a metal oxide capable of doping and dedoping lithium ions, SiO_{y} (0<v<2), SnO₂, vanadium oxide, lithium vanadium oxide, a composite including a metal compound and carbon material, a Si—C composite, a Sn—C composite, a transition metal oxide, Li_{4/3}Ti_{5/3}O₄, SnO, a carbonaceous material, graphite carbon fiber, resin calcination carbon, thermal decomposition vapor growth carbon, corks, mesocarbon microbeads (“MCMB”), furfuryl alcohol resin calcination carbon, polyacene, pitch-based carbon fiber, vapor growth carbon fiber, or natural graphite, and a composition of the formula NaₓSn_{y-z}M_{z} disposed between layers of the layered carbonaceous material, wherein M is Ti, K, Ge, P, or a combination thereof, and 0<x≤15, 1≤y≤5, and 0≤z≤1, as well as oxides, alloys, nitrides, fluorides of any of the foregoing, and any combination of any of the foregoing.

Embodiment 104: The method, electrode assembly, or secondary battery of any preceding Embodiment, wherein the electrode structure comprises an anode active material comprising at least one of lithium metal, a lithium metal alloy, silicon, silicon alloy, silicon oxide, tin, tin alloy, tin oxide, and a carbon-containing material.

Embodiment 105: The method, electrode assembly, or secondary battery of any preceding Embodiment, wherein the electrode structure comprises an anode active material comprising at least one of silicon and silicon oxide.

Embodiment 106: The method, electrode assembly, or secondary battery of any preceding Embodiment, wherein the electrode structure comprises an anode active material comprising at least one of lithium and lithium metal alloy.

Embodiment 107: The secondary battery and/or method according to any preceding Embodiment, wherein the electrode structure comprises an anode active material comprising a carbon-containing material.

Embodiment 108: The method, electrode assembly, or secondary battery of any preceding Embodiment, wherein the electrically insulating separator comprises a microporous separator material permeated with a non-aqueous liquid electrolyte.

Embodiment 109: The method, electrode assembly, or secondary battery of any preceding Embodiment, wherein the electrically insulating separator comprises a solid state separator comprising a solid electrolyte.

Embodiment 110: The method, electrode assembly, or secondary battery of any preceding Embodiment, wherein the electrically insulating separator comprises a ceramic material, glass or garnet material.

Embodiment 111: The electrode assembly or secondary battery of any preceding Embodiment, the electrode assembly comprising an electrolyte selected from the group consisting of non-aqueous liquid electrolytes, gel electrolytes, solid electrolytes and combinations thereof.

Embodiment 112: The electrode assembly or secondary battery of any preceding Embodiment, wherein the electrode assembly comprises a liquid electrolyte.

Embodiment 113: The electrode assembly or secondary battery of any preceding Embodiment, wherein the electrode assembly comprises an aqueous liquid electrolyte.

Embodiment 114: The electrode assembly or secondary battery of any preceding Embodiment, wherein the electrode assembly comprises a non-aqueous liquid electrolyte.

Embodiment 115: The electrode assembly or secondary battery of any preceding Embodiment, wherein the electrode assembly comprises a gel electrolyte.

Embodiment 116: The electrode assembly or secondary battery of any preceding Embodiment, wherein the electrically insulating separator comprises a solid electrolyte.

Embodiment 117: The electrode assembly or secondary battery of any preceding Embodiment, wherein the electrically insulating separator comprises a solid polymer electrolyte.

Embodiment 118: The electrode assembly or secondary battery of any preceding Embodiment, wherein the electrically insulating separator comprises a solid inorganic electrolyte.

Embodiment 119: The electrode assembly or secondary battery of any preceding Embodiment, wherein the electrically insulating separator comprises a solid organic electrolyte.

Embodiment 120: The electrode assembly or secondary battery of any preceding Embodiment, wherein the electrically insulating separator comprises a ceramic electrolyte.

Embodiment 121: The electrode assembly or secondary battery of any preceding Embodiment, wherein the electrically insulating separator comprises an inorganic electrolyte.

Embodiment 122: The electrode assembly or secondary battery of any preceding Embodiment, wherein the electrically insulating separator comprises a ceramic.

Embodiment 123: The electrode assembly or secondary battery of any preceding Embodiment wherein the electrically insulating separator comprises a garnet material.

Embodiment 124: The electrode assembly or secondary battery of any preceding Embodiment, comprising an electrolyte selected from the group consisting of aqueous electrolytes, a non-aqueous liquid electrolyte, a solid polymer electrolyte, a solid ceramic electrolyte, a solid glass electrolyte, a solid garnet electrolyte, a gel polymer electrolyte, an inorganic solid electrolyte, and a molten-type inorganic electrolyte.

Embodiment 125: The method, electrode assembly, or secondary battery of any preceding Embodiment, wherein counter-electrode structures comprise a cathodically active material comprising at least one of transition metal oxides, transition metal sulfides, transition metal nitrides, lithium-transition metal oxides, lithium-transition metal sulfides, lithium-transition metal nitrides, including transition metal oxides, transition metal sulfides, and transition metal nitrides having metal elements having a d-shell or f-shell, and/or where the metal element is any selected from Sc, Y, lanthanoids, actinoids, Ti, Zr, Hf, V, Nb, Ta, Cr, Mo, W, Mn, Tc, Re, Fe, Ru, Os, Co, Rh, Ir, Ni, Pb, Pt, Cu, Ag, and Au, LiCoO₂, LiNi_{0.5}Mn_{1.5}O₄, Li(NiₓCo_{y}Al_{z})O₂, LiFePO₄, Li₂MnO₄, V₂O₅, molybdenum oxysulfides, phosphates, silicates, vanadates, sulfur, sulfur compounds, oxygen (air), Li(NiₓMn_{y}Co_{z})O₂, lithium-containing compounds comprising metal oxides or metal phosphates, compounds comprising lithium, cobalt and oxygen (e.g., LiCoO₂), compounds comprising lithium, manganese and oxygen (e.g., LiMn₂O₄) compounds comprising lithium iron and phosphate (e.g., LiFePO), lithium manganese oxide, lithium cobalt oxide, lithium nickel oxide, lithium iron phosphate, lithium cobalt oxide (LiCoO₂), lithium nickel oxide (LiNiO₂), a substituted compound with one or more transition metals, lithium manganese oxide, Li₁₊ₓMn₂₋ₓO₄ (where, x is 0 to 0.33), LiMnO₃, LiMn₂O₃, LiMnO₂, lithium copper oxide (Li₂CuO₂), vanadium oxide, LiV₃O₅, LiFe₃O₄, V₂O₅, Cu₂V₂O₇, Ni site-type lithium nickel oxide represented by the chemical formula of LiNi₁₋ₓMₓO₂ (where, M=Co, Mn, Al, Cu, Fe, Mg, B or Ga, and x=0.01 to 0.3), lithium manganese complex oxide represented by the chemical formula of LiMn₂₋ₓMₓO₂ (where, M=Co, Ni, Fe, Cr, Zn or Ta, and x=0.01 to 0.1), Li₂Mn₃MO₈ (where, M=Fe, Co, Ni, Cu or Zn), LiMn₂O₄ in which a portion of Li is substituted with alkaline earth metal ions, a disulfide compound, Fe₂(MoO₄)₃, a lithium metal phosphate having an olivine crystal structure of Formula 2 Li₁₊ₐFe₁₋ₓM′ₓ(PO_{4-b})X_{b} wherein M′ is at least one selected from Al, Mg, Ni, Co, Mn, Ti, Ga, Cu, V, Nb, Zr, Ce, In, Zn, and Y, X is at least one selected from F, S, and N, −0.5≤a≤+0.5, 0≤x≤0.5, and 0≤b≤0.1, LiFePO₄, Li(Fe, Mn)PO₄, Li(Fe, Co)PO₄, Li(Fe, Ni)PO₄, LiCoO₂, LiNiO₂, LiMnO₂, LiMn₂O₄, LiNi_{1-y}Co_{y}O₂, LiCo_{1-y}Mn_{y}O₂, LiNi_{1-y}Mn_{y}O₂ (0≤y≤1), Li(NiₐCo_{b}Mn_{c})O₄ (0<a<2, 0<b<2, 0<c<2, and a+b+c=2), LiMn_{2-z}Ni_{z}O₄, LiMn_{2-z}Co_{z}O₄ (0<z<2), LiCoPO₄ and LiFePO₄, elemental sulfur (S8), sulfur series compounds, Li₂Sn (n≥1), an organosulfur compound, a carbon-sulfur polymer ((C₂Sₓ)ₙ: x=2.5 to 50, n≥2), an oxide of lithium and zirconium, a composite oxide of lithium and metal (cobalt, manganese, nickel, or a combination thereof), LiₐA_{1-b}M_{b}D₂ (wherein, 0.90≤a≤1, and 0≤b≤0.5), LiₐE_{1-b}M_{b}O_{2-c}D_{c} (wherein, 0.90≤a≤1, 0≤b≤0.5, and 0≤c≤0.05), LiE_{2-b}M_{b}O_{4-c}D_{c} (wherein, 0≤b≤0.5, and 0≤c≤0.05), LiₐNi_{1-b-c}Co_{b}M_{c}D_{c} (wherein, 0.90≤a≤1, 0≤b≤0.5, 0≤c≤0.05, and 0<a≤2), LiₐNi_{1-b-c}Co_{b}M_{c}O₂₋ₐXₐ (wherein, 0.90≤a≤1, 0≤b≤0.5, 0≤c≤0.05, and 0<a<2), LiₐNi_{1-b-c}Co_{b}M_{c}O₂₋ₐX₂ (wherein, 0.90≤a≤1, 0≤b≤0.5, 0≤5c≤0.05, and 0<a<2), LiₐNi_{1-b-c}Mn_{b}M_{c}Dₐ (wherein, 0.90≤a≤1, 0≤b≤0.5, 0≤c≤0.05, and 0<a≤2), LiₐNi_{1-b-c}Mn_{b}M_{c}O₂₋ₐXₐ (wherein, 0.90≤a≤1, 0≤b≤0.5, 0≤c≤0.05, and 0<a<2), LiₐNi_{1-b-c}Mn_{b}M_{c}O₂₋ₐX₂ (wherein, 0.90≤a≤1, 0≤b≤0.5, 0≤c≤0.05, and 0<a<2), LiₐNi_{b}E_{c}G_{d}O₂ (wherein, 0.90≤a≤1, 0≤b≤0.9, 0≤c≤0.5, and 0.001≤d≤0.1), LiₐNi_{b}Co_{c}Mn_{d}GeO₂ (wherein, 0.90≤a≤1, 0≤b≤0.9, 0<c≤0.5, 0≤d≤0.5, and 0.001≤e≤0.1), LiₐNiG_{b}O₂ (wherein, 0.90≤a≤1 and 0.001≤b≤0.1), LiₐCoG_{b}O₂ (wherein, 0.90≤a≤1 and 0.001≤b≤0.1), LiₐMnG_{b}O₂ (wherein, 0.90≤a≤1 and 0.001≤b≤0.1), LiₐMn₂G_{b}O₄ (wherein, 0.90≤a≤1 and 0.001≤b≤0.1), QO₂, QS₂, LiQS₂, V₂O₅, LiV₂O₅, LiX′O₂, LiNiVO₄, Li_{(3-f)}J₂(PO₄)₃ (0≤f≤2); Li_{(3-f)}Fe₂(PO₄)₃ (0≤f≤2), LiFePO₄. (A is Ni, Co, Mn, or a combination thereof; M is Al, Ni, Co, Mn, Cr, Fe, Mg, Sr, V, a rare-earth element, or a combination thereof; D is O, F, S, P, or a combination thereof; E is Co, Mn, or a combination thereof; X is F, S, P, or a combination thereof; G is Al, Cr, Mn, Fe, Mg, La, Ce, Sr, V, or a combination thereof; Q is Ti, Mo, Mn, or a combination thereof; X′ is Cr, V, Fe, Sc, Y, or a combination thereof; and J is V, Cr, Mn, Co, Ni, Cu, or a combination thereof), LiCoO₂, LiMnₓO₂ₓ (x=1 or 2), LiNi₁₋ₓMnₓO₂ₓ(0<x<1), LiNi_{1-x-y}CoₓMn_{y}O₂ (0<x<0.5, 0≤y≤0.5), FePO₄, a lithium compound, lithium cobalt oxide, lithium nickel oxide, lithium nickel cobalt oxide, lithium nickel cobalt aluminum oxide, lithium nickel cobalt manganese oxide, lithium manganese oxide, lithium iron phosphate, nickel sulfide, copper sulfide, sulfur, iron oxide, vanadium oxide, a sodium containing material, an oxide of the formula NaM¹ₐO₂ (wherein M¹ is at least one transition metal element, and 0≤a<1), NaFeO₂, NaMnO₂, NaNiO₂, NaCoO₂, an oxide represented by the formula NaMn₁₋ₐM¹ₐO₂ (wherein M¹ is at least one transition metal element, and 0≤a<1), Na[Ni_{1/2}Mn_{1/2}]O₂, Na_{2/3} [Fe_{1/2}Mn_{1/2}]O₂, an oxide represented by Na_{0.44}Mn₁₋ₐM¹ₐO₂ (wherein M¹ is at least one transition metal element, and 0≤a<1), an oxide represented by Na_{0.7}Mn₁₋ₐM¹ₐO_{2.05} an (wherein M¹ is at least one transition metal element, and 0≤a<1) an oxide represented by Na_{b}M²_{c}Si₁₂O₃₀ (wherein M² is at least one transition metal element, 2≤b≤6, and 2≤c≤5), Na₆Fe₂Si₁₂O₃₀, Na₂Fe₅Si₁₂O (wherein M² is at least one transition metal element, 2≤b≤6, and 2≤c≤5), an oxide represented by Na_{d}M³ₑSi₆O₁₈ (wherein M³ is at least one transition metal element, 3≤d≤6, and 1≤e≤2), Na₂Fe₂Si₆O₁₃, Na₂MnFeSi₆O₁₃ (wherein M³ is at least one transition metal element, 3≤d≤6, and 1≤e≤2), an oxide represented by Na_{f}M⁴_{g}Si₂O₆ (wherein M⁴ is at least one element selected from transition metal elements, magnesium (Mg) and aluminum (Al), 1≤f≤2 and 1≤g≤2), a phosphate, Na₂FeSiO₆, NaFePO₄, Na₃Fe₂(PO₄)₃, Na₃V₂(PO₄)₃, Na₄Co₃(PO₄)₂P₂O₇, a borate, NaFeBO₄ or Na₃Fe₂(BO₄)₃, a fluoride, NaₕM⁵F₆ (wherein M⁵ is at least one transition metal element, and 2≤h≤3), Na₃FeF₆, Na₂MnF₆, a fluorophosphate, Na₃V₂(PO₄)₂F₃, Na₃V₂(PO₄)₂FO₂, NaMnO₂, Na[Ni_{1/2}Mn_{1/2}]O₂, Na_{2/3}[Fe_{1/2}Mn_{1/2}]O₂, Na₃V₂(PO₄)₃, Na₄CO₃(PO₄)₂P₂O₇, Na₃V₂(PO₄)₂F₃ and/or Na₃V₂(PO₄)₂FO₂, as well as any complex oxides and/or other combinations of the foregoing.

Embodiment 126: The method, electrode assembly, or secondary battery of any preceding Embodiment, wherein the counter-electrode structures comprise a cathodically active material comprising at least one of a transition metal oxide, transition metal sulfide, transition metal nitride, transition metal phosphate, and transition metal nitride

Embodiment 127: The method, electrode assembly, or secondary battery of any preceding Embodiment, wherein the counter-electrode structures comprise a cathodically active material comprising a transition metal oxide containing lithium and at least one of cobalt and nickel.

Embodiment 128: The method, electrode assembly, or secondary battery of any preceding Embodiment, wherein the electrode structures comprise anode structures comprising anode current collectors comprising at least one of copper, nickel, aluminum, stainless steel, titanium, palladium, baked carbon, calcined carbon, indium, iron, magnesium, cobalt, germanium, lithium a surface treated material of copper or stainless steel with carbon, nickel, titanium, silver, an aluminum-cadmium alloy, and/or alloys thereof.

Embodiment 129: The electrode assembly or secondary battery of Embodiment 128, wherein the electrode structures comprise anode current collectors comprising at least one of copper, nickel, stainless steel and alloys thereof.

Embodiment 130: The method, electrode assembly, or secondary battery of any preceding Embodiment, wherein the counter-electrode structures comprise cathode structures comprising cathode current collectors comprising at least one of stainless steel, aluminum, nickel, titanium, baked carbon, sintered carbon, a surface treated material of aluminum or stainless steel with carbon, nickel, titanium, silver, and/or an alloy thereof.

Embodiment 131: The electrode assembly or secondary battery of Embodiment 130, wherein the cathode current collectors comprise at least one of stainless steel, aluminum, nickel, titanium, baked carbon, sintered carbon, a surface treated material of aluminum or stainless steel with carbon, silver, or an alloy thereof.

Embodiment 132: The electrode assembly or secondary battery of any preceding Embodiment, comprising a constraint system with first and second secondary growth constraints comprising any of stainless steel, titanium, or glass fiber composite.

Embodiment 133: The electrode assembly or secondary battery of Embodiment 132, comprising a constraint system with first and second secondary growth constraints comprising stainless steel.

Embodiment 134. The electrode assembly or secondary battery of any preceding Embodiment, comprising a constraint system with first and second secondary growth constraints comprising a coating of insulating material on inner and outer surfaces thereof.

Embodiment 135. The electrode assembly or secondary battery of any preceding Embodiment, wherein the electrode assembly comprises at least 5 electrode structures and at least 5 counter-electrode structures.

Embodiment 136. The electrode assembly or secondary battery of any preceding Embodiment, wherein the electrode assembly comprises at least 10 electrode structures and at least 10 counter-electrode structures.

Embodiment 137. The electrode assembly or secondary battery of any preceding Embodiment, wherein the electrode assembly comprises at least 50 electrode structures and at least 50 counter-electrode structures.

Embodiment 138. The electrode assembly or secondary battery of any preceding Embodiment, wherein the electrode assembly comprises at least 100 electrode structures and at least 100 counter-electrode structures.

Embodiment 139. The electrode assembly or secondary battery of any preceding Embodiment, wherein the electrode assembly comprises at least 500 electrode structures and at least 500 counter-electrode structures.

Embodiment 140. The method, electrode assembly, or secondary battery of any preceding Embodiment, wherein the counter-electrode structures comprise counter-electrode current collectors comprising aluminum.

Embodiment 141: A method of manufacturing the electrode assembly comprising the constraint system or secondary battery according to any of Embodiments 2-4 and 16-140 comprising:
(1) stacking the population of unit cells stacked in series in the stacking direction, wherein (i) each unit cell comprises the electrode structure, the counter-electrode structure, and the electrically insulating separator between the electrode and counter-electrode structures, (ii) the electrode structures, counter-electrode structures and electrically insulating separators within each unit cell have opposing upper and lower end surfaces separated in a vertical direction, and (iii) the vertical direction is orthogonal to the stacking direction,
(2) enclosing the population of unit cells within the volume defined by the constraint system comprising (i) first and second primary growth constraints separated in the longitudinal direction, and (ii) first and second secondary growth constraints separated in the vertical direction and connecting the first and second primary growth constraints, wherein (iii) the first secondary growth constraint is further connected to the upper end surfaces of the electrode or counter-electrode structures of a subset of the unit cell population, (iv) the second secondary growth constraint is further connected to the lower end surfaces of the electrode or counter-electrode structures of the subset of the unit cell population, and (v) the first or second secondary growth constraint comprises the plurality of apertures through a vertical thickness thereof,
(3) providing porous electrically insulating material within the plurality of apertures, the porous electrically insulating material providing the path for carrier ions through the apertures.

Embodiment 142: The method of manufacturing according to Embodiment 141, wherein the porous electrically insulating material is provided by filling the plurality of apertures with a slurry or paste comprising particulate material and binder material in a solvent, and evaporating the solvent to leave particulate material dispersed in the binder material in the plurality of apertures.

Embodiment 143: The method of manufacturing according to any of Embodiments 141-142, wherein the binder material is soluble in the solvent, and the solvent is evaporated by heating and/or drying of the solvent by gas flow.

Embodiment 144: The method of manufacturing according to any of Embodiments 141-143, wherein solvent comprises any of N-methyl-2-pyrrolidone (NMP), heptane, octane, toluene, xylene, or mixed hydrocarbon solvents.

Embodiment 145: The method of manufacturing according to any of Embodiments 141-144, wherein the slurry and/or paste comprises at least 50 wt % of particulate material.

Embodiment 146: The method of manufacturing according to any of Embodiments 141-145, wherein the slurry and/or paste comprises at least 55 wt % of particulate material.

Embodiment 147: The method of manufacturing according to any of Embodiments 141-146, wherein the slurry and/or paste comprises at least 60 wt % of particulate material.

Embodiment 148: The method of manufacturing according to any of Embodiments 141-147, wherein the slurry and/or paste comprises at least 65 wt % of particulate material.

Embodiment 149: The method of manufacturing according to any of Embodiments 141-148, wherein the slurry and/or paste comprises at least 70 wt % of particulate material.

Embodiment 150: The method of manufacturing according to any of Embodiments 141-149, wherein the slurry and/or paste comprises at least 75 wt % of particulate material.

Embodiment 151: The method of manufacturing according to any of Embodiments 141-150, wherein the slurry and/or paste comprises at least 80 wt % of particulate material.

Embodiment 152: The method of manufacturing according to any of Embodiments 141-151, wherein the slurry and/or paste comprises no more than 90 wt % of particulate material.

Embodiment 153: The method of manufacturing according to any of Embodiments 141-152, wherein the slurry and/or paste comprises no more than 85 wt % of particulate material.

Embodiment 154: The method of manufacturing according to any of Embodiments 141-153, wherein the slurry and/or paste comprises no more than 80 wt % of particulate material.

Embodiment 155: The method of manufacturing according to any of Embodiments 141-154, wherein the slurry and/or paste comprises no more than 75 wt % of particulate material.

Embodiment 156: The method of manufacturing according to any of Embodiments 141-155, further comprising: connecting first and second secondary growth constraints separated in the vertical direction to electrode current collectors of members of the electrode structures, the first and second secondary growth constraints comprising apertures formed through respective vertical thicknesses thereof, wherein the first and second secondary growth constraints at least partially restrain growth of the electrode assembly in the vertical direction upon cycling of the electrode assembly.

Embodiment 157: The method of manufacturing according to any of Embodiments 141-156, comprising
(1) positioning the auxiliary electrode comprising the source of carrier ions external to volume enclosed by the constraint system,
(2) applying a bias voltage between the auxiliary electrode and the electrode structures or counter-electrode structures of members of the unit cell population to provide a flow of carrier ions through the apertures in the first or second secondary growth constraints and through the porous electrically insulating material in the apertures to members of the unit cell population.

Embodiment 158: The method of manufacturing according to any of Embodiments 141-157, comprising performing the method for transferring carrier ions from the auxiliary electrode comprising the source of carrier ions to the electrode assembly during the initial or subsequent charging cycle of the secondary battery according to any of Embodiments 1 and 5-15.

Embodiment 159: The method, electrode assembly, or secondary battery according to any of Embodiments 1-16 and 29-158, wherein the porous electrically insulating material has a porosity in the range of from 20% to 60%.

### INCORPORATION BY REFERENCE

All publications and patents mentioned herein, including those items listed below, are hereby incorporated by reference in their entirety for all purposes as if each individual publication or patent was specifically and individually incorporated by reference. In case of conflict, the present application, including any definitions herein, will control.

### EQUIVALENTS

While specific embodiments have been discussed, the above specification is illustrative, and not restrictive. Many variations will become apparent to those skilled in the art upon review of this specification. The full scope of the embodiments should be determined by reference to the claims, along with their full scope of equivalents, and the specification, along with such variations.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained.

1. A method for transferring carrier ions from an auxiliary electrode comprising a source of carrier ions to an electrode assembly through a constraint system, wherein
the electrode assembly comprises a population of unit cells stacked in series in a stacking direction, wherein (i) each unit cell comprises an electrode structure, a counter electrode structure, and an electrically insulating separator between the electrode and counter-electrode structures, (ii) the electrode structures, counter-electrode structures and electrically insulating separators within each unit cell have opposing upper and lower end surfaces separated in a vertical direction, (iii) the vertical direction is orthogonal to the stacking direction,
the electrode assembly is enclosed within a volume defined by the constraint system, the constraint system comprising (i) first and second primary growth constraints separated in the stacking direction, and (ii) first and second secondary growth constraints separated in the vertical direction and connecting the first and second primary growth constraints, wherein (iii) the first secondary growth constraint is further connected to the upper end surface(s) of the electrode or counter-electrode structures of a subset of members of the unit cell population, (iv) the second secondary growth constraint is further connected to the lower end surface(s) of the electrode or counter-electrode structures of a subset of members of the unit cell population, (v) the first or second secondary growth constraint comprises a plurality of apertures through a vertical thickness thereof, and a porous electrically insulating material disposed within the plurality of apertures, the porous electrically insulating material providing a path for carrier ions through the apertures, the porous electrically insulating material having a porosity in the range of from 20% to 60%,
the auxiliary electrode is located outside the volume enclosed by the constraint system, and
the method comprises transferring carrier ions from the auxiliary electrode through the porous electrically insulating material within the apertures to members of the unit cell population.

2. An electrode assembly comprising a constraint system for a secondary battery, the electrode assembly comprising:
a population of unit cells stacked in series in a stacking direction, wherein (i) each unit cell comprises an electrode structure, a counter-electrode structure, and an electrically insulating separator between the electrode and counter-electrode structures, (ii) the electrode structures, counter-electrode structures and electrically insulating separators within each unit cell have opposing upper and lower end surfaces separated in a vertical direction, (iii) the vertical direction is orthogonal to the stacking direction,
wherein the electrode assembly is enclosed within a volume defined by the constraint system, the constraint system comprising (i) first and second primary growth constraints separated in the longitudinal direction, and (ii) first and second secondary growth constraints separated in the vertical direction and connecting the first and second primary growth constraints, wherein (iii) the first secondary growth constraint is further connected to the upper end surfaces of the electrode or counter-electrode structures of a subset of the unit cell population, (iv) the second secondary growth constraint is further connected to the lower end surfaces of the electrode or counter-electrode structures of a subset of the unit cell population, (v) the first or second secondary growth constraint comprises a plurality of apertures through a vertical thickness thereof, and a porous electrically insulating material disposed within the plurality of apertures, the porous electrically insulating material providing a path for carrier ions through the apertures, the electrically insulating material having a porosity in the range of from 20% to 60%.

3. A secondary battery comprising the electrode assembly of claim 2.

4. The electrode assembly of claim 2, wherein both the first and second secondary growth constraints comprise the plurality of apertures.

5. The method of claim 1 further comprising aligning the auxiliary electrode over apertures in the first or second secondary growth constraint, and applying a pressure in a range of greater than 0 psi to no more than 20 psi to press the auxiliary electrode and the first or second secondary growth constraint against one another.

6. The method of claim 1, further comprising applying a pressure in a range of greater than 5 psi to no more than 20 psi to press the auxiliary electrode and the first or second secondary growth constraint against one another.

7. The method of claim 1, wherein the pressure is applied to contact the auxiliary electrode with porous electrically insulating material disposed in the apertures.

8. The method of claim 1, wherein carrier ions are transferred to achieve and/or restore a predetermined counter-electrode structure end of discharge voltage Vces eod, and a predetermined electrode structure end of discharge voltage Ves.eod.

9. The method of claim 1, wherein the carrier ions are transferred to replenish carrier ions lost to the formation of SEI.

10. The method of claim 1, wherein the carrier ions are transferred to compensate for a loss of carrier ions during an initial or subsequent charging cycle of the electrode assembly.

11. The method of claim 1, further comprising:
(i) transferring carrier ions from counter-electrode structures to electrode structures in the unit cell population during an initial or subsequent charging cycle to at least partially charge the electrode assembly, and
(ii) transferring carrier ions from the auxiliary electrode, to counter-electrode structures and/or electrode structures, through the porous electrically insulating material, the auxiliary electrode being electrolytically coupled to the counter-electrode structure and/or electrode structure of members of the unit cell population, through the separator, to provide the electrode assembly with the predetermined counter-electrode structure end of discharge voltage Vcos.eod, and the predetermined electrode structure end of discharge voltage Ves.eod.

12. The method of claim 11 further comprising (iii) transferring, after (ii), carrier ions from the counter-electrode structure to the electrode structure of members of the unit cell population to charge the electrode assembly.

13. The method of claim 12, wherein (ii) is performed simultaneously with (i).

14. The method of claim 11 further comprising, in (ii), applying a bias voltage between the auxiliary electrode and the electrode structure or counter electrode structure of members of the unit cell population to provide a flow of carrier ions through the porous electrically insulating material.

15. The electrode assembly of claim 2, wherein the electrode structures of the members of the unit cell population comprise electrode active material layers and electrode current collector layers, and the counter electrode structures of members of the unit cell population comprise counter-electrode active material layers and counter-electrode current collector layers.

16. The electrode assembly of claim 2, wherein the porous electrically insulating material comprises a porosity of at least 25%, at least 30%, at least 35%, at least 40%, at least 45%, at least 50%, or at least 55%.

17. The electrode assembly of claim 2, wherein the porous electrically insulating material comprises a porosity of no more than 55%, no more than 50%, no more than 45%, no more than 40%, or no more than 35%.

18. The electrode assembly of claim 2, wherein the electrically insulating separator is microporous and a ratio of the porosity of the porous electrically insulating material to a porosity of the electrically insulating separator is in a range of from 1:0.75 to 1:1.5.

19. The electrode assembly of claim 2, wherein the porous electrically insulating material comprises a particulate material dispersed in a binder material.

20. The electrode assembly of claim 19, wherein the binder material comprises a polymeric material selected from any of the group consisting of polyvinylidene fluoride (PVDF), polyethylene, polypropylene, ethylene acrylic acid (EAA), ethylene methacrylic acid (EMAA), and copolymers thereof.

21.-30. (canceled)
